(19) United States
(12) Patent Application Publication
(10) Pub. No.: US 2026/0175434 A1
(43) Pub. Date: Jun. 25, 2026

(54) ROBOTIC GRIPPER AND METHODS OF OPERATING THE SAME

(71) Applicant: Dubai Future Foundation, Dubai (AE)

(72) Inventors: Rajkumar Muthusamy, Dubai (AE); Karim Haddad, Dubai (AE); Tanzim Ahmed, Dubai (AE); Tarek Taha, Dubai (AE); Khalifa AlQama, Dubai (AE)

(73) Assignee: Dubai Future Foundation, Dubai (AE)

(21) Appl. No.: 19/426,436

(22) Filed: Dec. 19, 2025

Related U.S. Application Data
(60) Provisional application No. 63/737,078, filed on Dec. 20, 2024.

(51) Int. Cl. B25J 9/16

(52) U.S. Cl. CPC B25J 9/1694; B25J 9/1664

(57) ABSTRACT

A robotic gripper for performing grasping operations. The robotic gripper comprises a microcontroller; a chassis; a first sensor and a second sensor coupled to the chassis and configured to provide sensor data to the microcontroller; and a first appendage and a second appendage coupled to the chassis and controllable by the microcontroller to perform gripping operation on an object. The microcontroller is configured to process sensor data to evaluate the gripping operation and to execute suitable gripping operations on the object using the first appendage and a second appendage based on the sensor data.

### RELATED APPLICATION

The present application claims priority to and benefit from U.S. provisional patent application No. 63/737,078 filed on Dec. 20, 2025, and entitled “ROBOTIC GRIPPER AND METHODS OF OPERATING THE SAME,” the entirety of which is hereby incorporated by reference herein.

### TECHNICAL FIELD

The present disclosure relates to a robotic gripper and methods of operating the robotic gripper, particularly to the operation of the robotic gripper using sensor data.

### BACKGROUND

Robotic grippers are critical components in automated systems, enabling robots to manipulate objects across various industries. These end-effectors are designed to mimic the grasping and holding functions of human hands and come in diverse designs tailored to specific tasks and materials. Common types include mechanical grippers with motorized fingers or jaws, vacuum grippers for smooth surfaces, magnetic grippers for ferrous materials, and soft grippers for delicate or irregularly shaped objects.

Robotic manipulation focuses on enabling robots to safely and securely interact with objects in diverse and unpredictable environments. This field is pivotal for advancing automation in industries such as manufacturing, healthcare, and logistics, where operational safety and reliability are critical. However, challenges persist due to dynamic environmental factors like motion, occlusion, or lighting changes, which can compromise grasp security. Traditional rigid grippers, reliant on precise object and grasp pose estimation (OPE & GPE), often fall short in unstructured settings, prompting a shift toward innovations like soft robotics. This has created a demand for further innovation that builds on the foundations of existing end-to-end automation solutions.

Despite advancements, several challenges persist in robotic gripper design. Many grippers lack versatility, struggling to handle a wide range of object shapes, sizes, and materials. Achieving human-like precision, dexterity, and force control remains a significant goal, especially for tasks involving fragile or complex items. Additionally, handling varying textures, weights, and surface finishes effectively while maintaining cost-efficiency continues to be a technical hurdle.

Accordingly, new and/or improved robotic grippers and methods for operating the robotic grippers remain highly desirable.

### SUMMARY

In accordance with one aspect of the present disclosure, a robotic gripper is disclosed, comprising: a microcontroller; a chassis; a first sensor and a second sensor coupled to the chassis and configured to provide sensor data to the microcontroller; and a first appendage and a second appendage coupled to the chassis and controllable by the microcontroller to perform gripping operation on an object; the microcontroller configured to process sensor data to evaluate the gripping operation and to execute the gripping operation using the first appendage and a second appendage based on the sensor data.

In some aspects, the first sensor is a RGB-D camera or a RGB camera coupled to a depth sensor; and the sensor data comprises first sensor data provided by the first sensor and comprising RGB frames and depth frames.

In some aspects, the second sensor is a neuromorphic camera; and the sensor data comprises second sensor data provided by the second sensor and comprising event frames and/or event streams.

In some aspects, the first appendage and/or the second appendage is a cable driven appendage; the cable driven appendage comprises a cable along a longitudinal direction thereof actuatable to curl the cable driven appendage in a direction of the gripping operation; and the cable driven appendage is formed from a soft material.

In some aspects, the first appendage and/or the second appendage is a belt driven appendage; the belt driven appendage comprises a belt configured to move in a direction of the gripping operation; and the belt driven appendage is formed from a high-friction and/or soft material.

In some aspects, the belt driven appendage comprises a plurality of markers for evaluation of the gripping operation.

In some aspects, the chassis comprises a plurality of modular compartments coupled thereto; each of the plurality of the compartments corresponds to a respective appendage and comprises: a first actuator configured to control a movement of the respective appendage to perform the gripping operation; and a second actuator configured to control a distance of the respective appendage to another appendage.

In some aspects, the robotic gripper further comprises one or more additional appendages.

In some aspects, the gripping operation is gripping, grasping, tapping, caging, pivoting, picking, pushing, sliding, holding, or combinations thereof.

In some aspects, the second sensor data is for evaluating a contact between the first appendage and/or second appendage with the object.

In some aspects, the microcontroller is configured to receive a 3D representation of the first appendage, second appendage, and/or the object for evaluating the gripping operation and/or object detection.

In some aspects, the microcontroller is configured to receive object properties comprising: deformability, size, weight, material properties, or combinations thereof from a large language model for evaluating the gripping operation.

In some aspects, the microcontroller is configured to classify a quality of the gripping operation to evaluate the gripping operation using a scoring system.

In accordance with another aspect of the present disclosure, a method for performing gripping operation on an object using a robotic gripper is disclosed, comprising: estimating a pose of the object by using 3D representations of the object and the robotic gripper to perform region of interest detection to estimate the pose; planning the gripping operation based on the pose using sensor data and object properties determined by a large language model to determine a contact point and the gripping operation; executing the gripping operation using the robotic gripper; and evaluating the gripping operation using sensor data.

In some aspects, evaluating the gripping operation comprises: monitoring the gripping operation using the sensor data; adjusting the gripping operation using the sensor data; and scoring the gripping operation using the sensor data.

In some aspects, monitoring the gripping operation comprises evaluating a contact between the robotic gripper and the object and adjusting the gripping operation comprises adjusting the gripping operation using the object properties.

In some aspects, evaluating the contact between the robotic gripper and the object comprises: detecting overlap between the robotic gripper and the object from pixel changes in the sensor data; evaluating kinematics of the robotic gripper using visual data of markers on the robotic gripper; and detecting contact and/or slippage between the object and the robotic gripper.

In accordance with another aspect of the present disclosure, a robotic manipulator comprising the robotic gripper of any one of the above aspects is disclosed.

In accordance with another aspect of the present disclosure, a robotic gripper system is disclosed, comprising: a microcontroller comprising at least one processing unit; a chassis; a first sensor and a second sensor coupled to the chassis and configured to provide sensor data to the microcontroller; and a first appendage and a second appendage coupled to the chassis and controllable by the microcontroller to perform gripping operation on an object; the at least one processing unit is configured to perform the method of any one of the above aspects.

In accordance with another aspect of the present disclosure, a robotic gripper system is disclosed, comprising: the robotic gripper of any one of the above aspects; and at least one processing unit is configured to perform the method of any one of the above aspects.

In accordance with another aspect of the present disclosure, at least one non-transitory computer readable medium having stored thereon computer instruction is disclosed, which, when executed by at least one processor, causes the at least one processor to perform the method of any one of the above aspects.

### BRIEF DESCRIPTION OF THE DRAWINGS

Further features and advantages of the present disclosure will become apparent from the following detailed description, taken in combination with the appended drawings, in which:

FIGS. 1A-1B and 2A-2C depict a robotic gripper, according to example embodiments.

FIG. 2D depicts a portion of the robotic gripper of FIGS. 1A-2C

FIGS. 3A-5B depict alternative implementations of the robotic gripper of FIGS. 1A-2C, according to example embodiments.

FIG. 6 depicts the fields of view of sensors on the robotic gripper of FIGS. 1A-2C, according to an example embodiment.

FIG. 7 depicts ranges of gripping operations for the robotic gripper of FIGS. 1A-2C, according to an example embodiment.

FIG. 8 depicts a robotic system comprising the robotic gripper of FIGS. 1A-2C, according to an example embodiment.

FIG. 9A-9D depicts gripping operation evaluation by the robotic gripper of FIGS. 1A-2C, according to example embodiments.

FIG. 10 depicts use of sensor data for performing gripping operation using the robotic gripper of FIGS. 1A-2C, according to an example embodiment.

FIG. 11 depicts evaluations of gripping operation using the robotic gripper of FIGS. 1A-2C, according to an example embodiment.

FIG. 12 depicts a method for performing gripping operation using the robotic gripper of FIGS. 1A-2C, according to an example embodiment.

FIGS. 13 and 14 depict execution of gripping operations using the robotic gripper of FIGS. 1A-2C, according to example embodiments.

FIG. 15 depicts the robotic gripper of FIGS. 1A-2C implemented as a system, according to an example embodiment.

FIGS. 16A and 16B depict methods for operating the robotic gripper of FIGS. 1A-2C, according to example embodiments.

FIGS. 17A-17G depict performances of the robotic gripper of FIGS. 1A-2C, according to example embodiments.

It will be noted that throughout the appended drawings, like features are identified by like reference numerals.

### DETAILED DESCRIPTION

In modern industrial environments and service sectors such as warehouses, retail stores, and homes, robots must handle a wide variety of objects with different shapes, sizes, and material properties. These objects can be fragile, rigid, or soft and are often scattered or cluttered in bins or on shelves, sometimes in orientations or environments that make them difficult to grasp. To address these challenges, gripper systems, in particular robotic grippers, must be modular, scalable, cost-effective, and software-adaptive, capable of quickly inferring information from the environment and responding to changes in real-time. They should perform both simple grasping and complex manipulation operations, especially for objects that are technically graspable but not accessible due to their orientation or environmental constraints. The present disclosure can overcome the limitations of traditional grippers in Industry 4.0, fostering the integration of advanced digital technologies into manufacturing and industrial processes with emphasis on automation, real-time data exchange, and smart systems, enabling a highly interconnected and autonomous production environment. As such, the present disclosure can also enhance the ability of the robotic gripper to handle diverse objects and enable robust grasping and complex manipulation in constrained environments. Accordingly, integrating the gripper system with robots can enable comprehensive end-to-end manipulations.

End-to-end automation in robotic manipulation aims to seamlessly execute the entire process from object detection to task completion without human intervention. This approach is essential for applications like automated warehouses or assistive robotics, where consistent performance across diverse objects is critical. Challenges include dynamic environmental changes and the need for real-time adaptability, often requiring robust sensing and control systems. Recent advancements, including soft grippers and advanced algorithms, have improved automation by enabling adaptive grasping and error correction. The present disclosure introduces a novel sensorized soft gripper designed with human-inspired grasping for safe end-to-end automation. It features multi-modal vision to monitor finger-object-environment interactions. This design can serve as an intermediate safety checkpoint between initial grasp and in-hand manipulation to increase the success rate of repetitive manipulation tasks.

The present disclosure relates to a sensorized multi-modal soft gripper system (e.g. robotic gripper) designed for robust grasping and complex manipulation tasks. The term “gripper system” can refer to the robotic gripper or a system comprising various components coupled thereto. The term “gripping operation” can refer to manipulation or movement of an object using the robotic gripper, for example, gripping operation can be grasping, gripping, holding, pushing, sliding, tapping, trapping, caging, pivoting, picking, etc. The term “sensorized” can refer to the integration of sensors within the gripper to provide real-time feedback on the gripper's interaction with items and the environment, as well as the operational workspace. The term “multi-modal” can refer to the use of multiple actuation mechanisms and sensing modalities to handle a wide variety of items and tasks. The term “soft gripper” can refer to a gripper made from soft, flexible materials that allow it to conform to the shape of the objects it grasps, making it suitable for handling delicate, fragile, or irregularly shaped items. The term “system” can refer to a system that combines the soft gripper, integrated sensors, multi-modal actuation and sensing, and necessary hardware and software, to form a robotic gripper unit designed for real-world tasks and applications. The multi-modal sensing and actuation, and end-to-end grasping and manipulation pipeline, as disclosed herein, can be integrated with a robot manipulator to perform tasks that are challenging for traditional grippers and under workspace constraints.

The innovative design and advanced capabilities of the present disclosure can provide a variety of applications within Industry 4.0. The disclosed robotic gripper and methods of operating the same can address the challenges posed by objects in difficult orientations or constrained environments, making it ideal for use in warehouses, retail stores, and other settings that require the handling of a diverse array of items. The integration of multi-modal sensing and advanced perception techniques can ensure robust and adaptive grasping and manipulation, overcoming traditional limitations and enhancing operational efficiency.

In particular, the present disclosure can address the challenge of reliably grasping and manipulating (e.g. gripping operations) irregularly shaped and non-standard objects in dynamic and constrained environments. Traditional robotic grippers often fall short due to inadequate sensory feedback and adaptability, leading to unsuccessful grasps and limited manipulation capabilities, particularly in complex settings like warehouses, retail stores, and homes. These environments frequently present objects that are scattered, cluttered, or positioned in difficult orientations, complicating effective handling. The present disclosure can integrate advanced sensing and actuation technologies with a robotic gripper to handle a diverse array of objects, perform both simple and complex manipulations, and adapt in real-time to varying conditions. By enhancing the robotic gripper's ability to manage objects effectively in constrained environments, the present disclosure can significantly improve operational efficiency and versatility in modern industrial and service applications.

Existing solutions for robotic grasping and manipulation typically use rigid or soft grippers with limited sensory capabilities. While various gripper designs and camera placements within the gripper or palm have been developed to evaluate grasps, these solutions often target specific aspects of grasping or manipulation. The complexity of these systems is compounded by multiple integrations and a heavy reliance on predefined object models, making them less adaptable to unforeseen variations in object shapes, sizes, and orientations. Traditional tactile sensing methods, which use image processing and computer vision, frequently struggle to deliver the real-time feedback required for dynamic interactions and face reliability issues due to wear and tear on contact surfaces.

Several existing technologies attempt to address these challenges with varying degrees of success. Internal vision sensors (e.g. within fingers of a robotic gripper) can refer to systems developed with a focus on placing vision sensors inside the fingers using mirrors and lighting mechanisms to observe the displacement of markers and infer tactile information. These systems extend the applicability of a single camera by splitting views to observe both the scene and the tactile activity inside the finger. This approach facilitates precise interaction with the end tool fitted in the gripper. Infrared camera-based grippers (e.g. at palm of a robotic gripper) can refer to gripping devices where an infrared camera is placed in the palm of the gripper to evaluate the grasp. This method provides some level of tactile feedback but is limited in its ability to handle dynamic and complex interactions. Multi-fingered end effectors with optical sensors (e.g. within fingers of a robotic gripper) can refer to a multi-fingered end effector that integrates optical distance sensors within the fingers to detect the distance to an object prior to contact. Additionally, these fingers may include optical proximity sensors to measure the force applied to the object post-contact. While this approach improves the pre-grasp and contact-phase sensing, it does not fully address the adaptability required for complex manipulation tasks.

Further, GPE remains a significant challenge in robotic manipulation. GPE aims to accurately determine a gripper's optimal position and orientation to securely grasp an object. This process is vital for safe automation but is limited by object variability, occlusion, and poor lighting in unstructured environments. Traditional methods depend on depth sensors or RGB cameras for OPE, yet these often fail under real-world conditions. Deep learning has enhanced GPE by predicting poses from visual data, though it demands extensive training datasets. The present disclosure can mitigate these issues by implementing a system that predicts the success rate of a grasp. This prediction can prompt safety measures to restructure or reattempt a grasp.

For object slip detection, neuromorphic imaging uses sensors that mimic human vision, where pixels update independently to capture changes in light. This allows it to achieve latencies many orders faster than traditional cameras. Neuromorphic slip detection is a recent addition to the world of safe manipulation. It has been aimed at identifying and correcting object slippage during grasping to maintain safety in automated tasks. Slippage poses risks of task failure or object damage, particularly with fragile or deformable items, necessitating real-time monitoring. Industry trends utilize high-speed event cameras and tactile sensors to detect slip with low latency, enabling immediate corrective actions. The present disclosure can utilize an event camera to capture rapid scene changes, supporting dynamic manipulation experiments at varying speeds and validating the gripper's robustness across object categories. This capability can enhance safety by preventing grasp failures, contributing to secure automation.

Accordingly, the present disclosure provides a sensorized multi-modal gripper system configured to perform both robust grasping and complex manipulation of objects. Some aspects of the present disclosure includes:

Externally Positioned Dual-Set Vision Sensors: The gripper system can feature externally positioned dual-set vision sensors that observe the fingers, object, and environment. These sensors can capture comprehensive visual data to infer the flow of information necessary for regulating gripping and manipulation actions.

Multi-Modal Sensing and Actuation: The gripper system can utilize a combination of proprioception (internal state sensing) and exteroception (external sensory information) through visual-tactile information. This can include kinematic data, contact detection, slip detection, object pose estimation, and more, providing real-time feedback for dynamic interactions.

Soft Fingers with Dual Actuation: The gripper can include a thumb-inspired soft finger and a cable-driven soft finger, enhancing adaptability and versatility. The dual-actuation system (cable-driven and linear actuation) can allow for nuanced control and adjustment during grasping and manipulation.

Advanced Perception Techniques: Integration of a neuromorphic event camera and an RGB-D camera can capture both static and dynamic changes in the environment. This combination can enable real-time detection of contact, slip, object translation, and rotation, supporting complex manipulation tasks and robust grasps of non-standard objects.

Modularity and Scalability: The design and methods of the gripper system can be modular and scalable, allowing customization for various applications. The sensorized soft gripping system can guide robot arm motions and gripper actions, performing end-to-end manipulation tasks efficiently.

Accordingly, the present disclosure may be applied to warehouse automation, retail and e-commerce, healthcare and pharmaceuticals, consumer robotics, agriculture and food processing, logistics and supply chain, research and development, and space exploration.

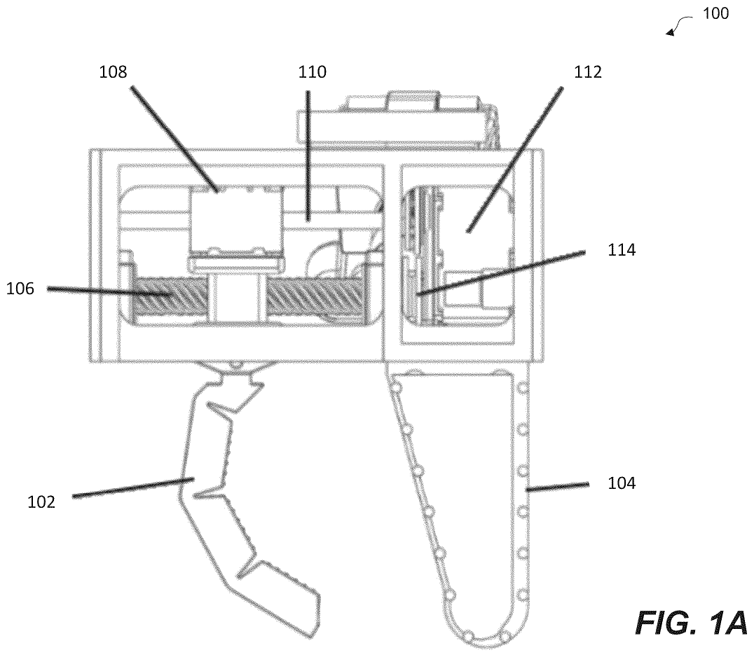

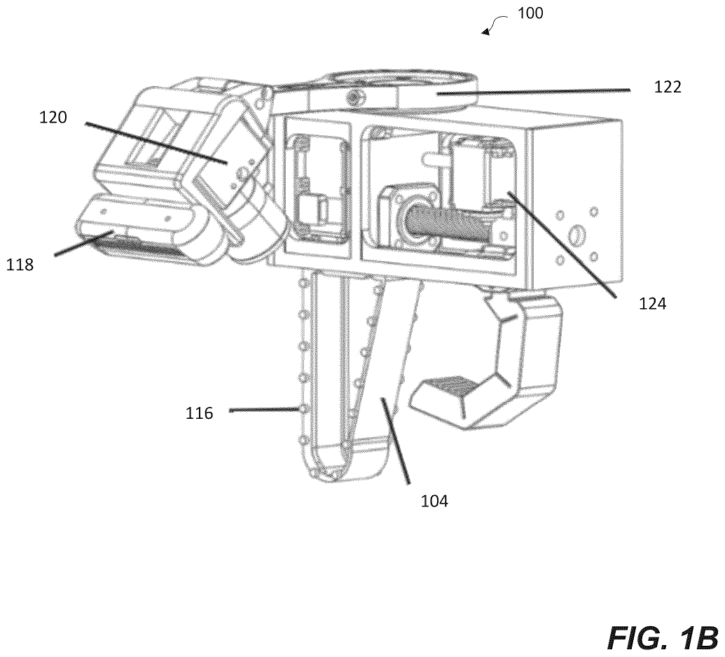

Embodiments are described below, by way of example only, with reference to FIGS. 1A-17G.

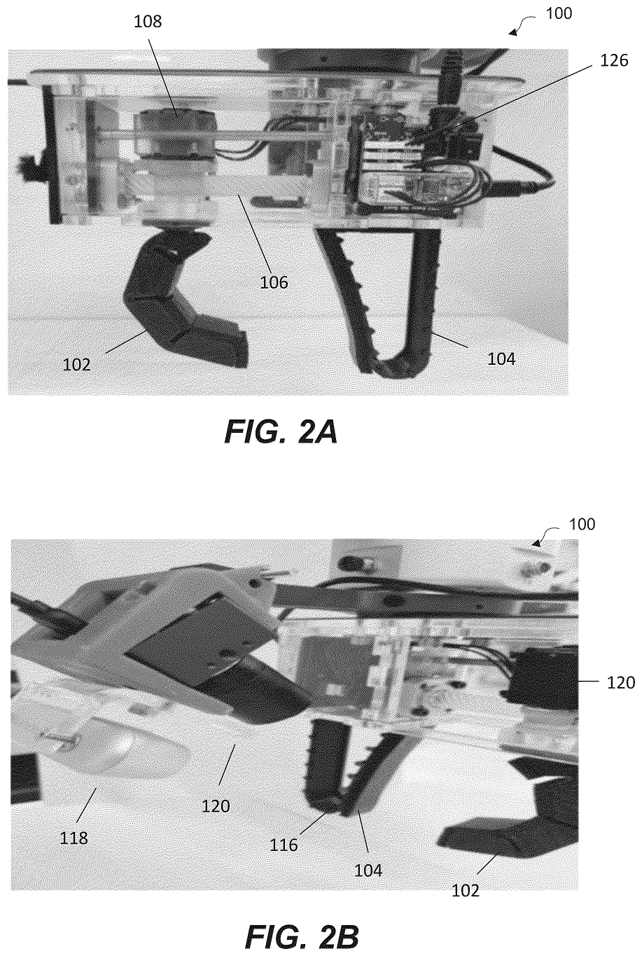

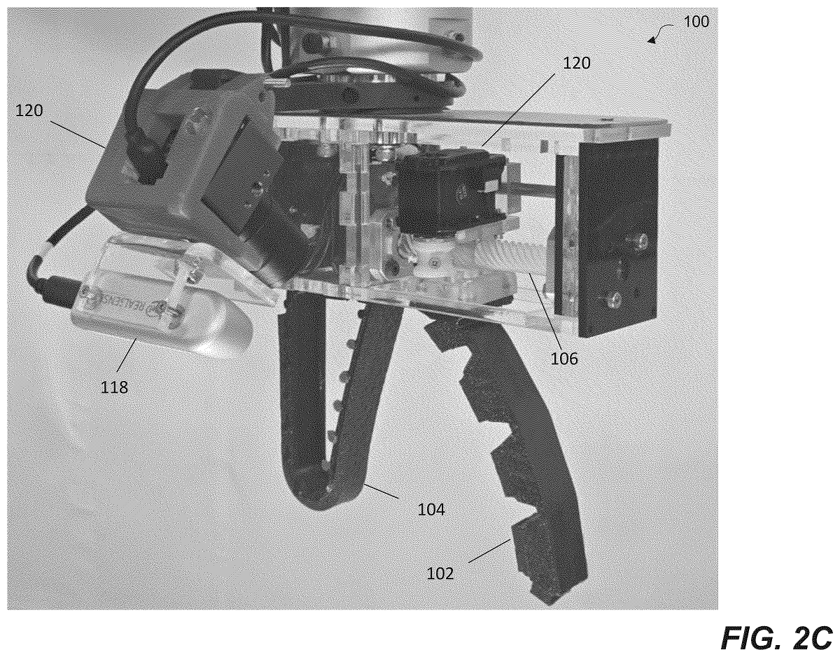

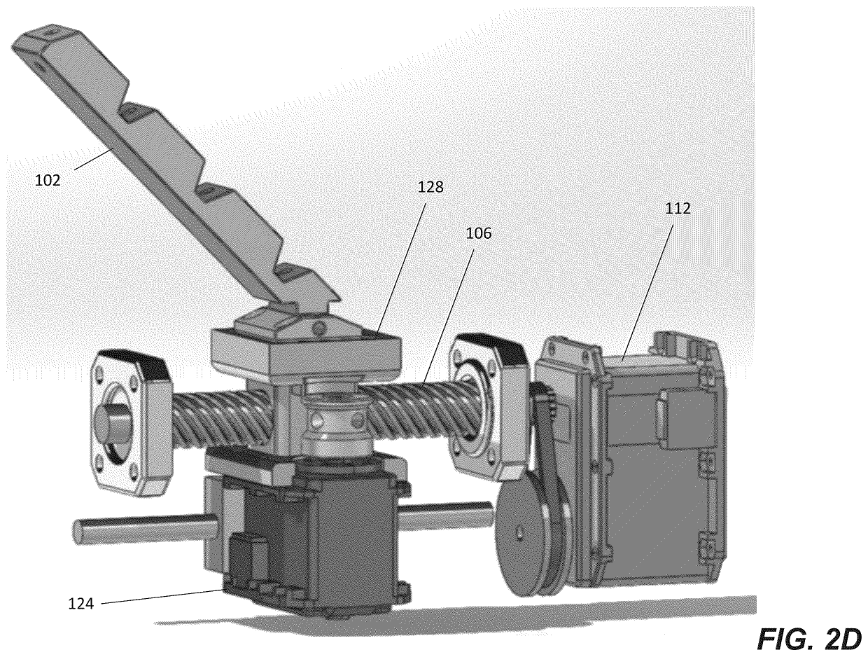

FIGS. 1A-2C depict representations of a robotic gripper 100. The robotic gripper 100 can comprise a plurality of robotic fingers or appendages. The appendages are configured to contact an object, which can be the target for gripping operation. In particular, the appendages can be used in combination to grasp or grip the object (e.g. between the appendages). The appendages can also be configured to conform to the shape of the object during gripping operation. In particular, the appendages may be formed from soft, flexible material to ensure gentle contact and compliance during gripping operation, making them suitable for handling delicate and irregularly shaped items. In some embodiments, the appendages can be formed from polymer, plastic, rubber, etc, and may be 3D-printed. In some embodiments, the appendages may be 3D printed using TPU™ 95A.

As depicted in FIGS. 1A-2B, the robotic gripper 100 can be implemented with a cable-driven finger 102 as an appendage. The cable-driven finger 102 can comprise a cable running along the length of the finger configured to be actuated by a rotary motor 124 (FIG. 1B), which can comprise a spool and be actuated to retract or release the cable. At rest, the cable driven finger 102 may be relaxed and may be substantially straight along its longitudinal length. By actuating the rotary motor 124, the cable can be retracted, causing the cable-driven finger 102 to curl or incline towards its base and another appendage (and the object to be grasped) to perform the gripping operation. The retraction of the cable and curling of the cable-driven finger 102 can also provide the necessary force for grasping or holding the object. By releasing the cable, the cable-driven finger 102 can be returned to the rest position, for example to release the object and suspend/terminate gripping operation. The cable-driven finger 102 can comprise joints to control a curling configuration and/or surface features to better secure the object.

Another implementation of an appendage is a belt-drive finger 104, as depicted in FIGS. 1A-2C. The belt-drive finger 104 may be a thumb-inspired finger comprising a belt facing another appendage and/or the object during gripping operation. The belt-driven finger may be arranged substantially vertically at a side for grasping the object. Alternatively, the object grasping side may be inclined at an angle. For example, FIGS. 1A-2C depict the belt-drive finger 104 as inclined away from the cable-driven finger 102. The movement of the belt is configured to move the object in a desired direction, such as the direction required by the gripping operation (e.g. upwards). The belt can also move in the opposite direction to release the object. The belt-drive finger 104 can be actuated using a motor or gear 114 to move the belt in both directions. Visual markers 116 may be embedded or otherwise indicated on the belt to allow for the tracking and monitoring of the movement of the belt as well as for evaluation of the gripping operation, as described further herein. In the current embodiment, 5 markers 116 are provided.

A linear actuator 112 such as a motor can be used to control a distance between appendages in order to perform gripping operations by moving an appendage coupled thereto. As depicted in FIGS. 1A-2C, the cable-driven finger 102 is movable along a lateral ball screw 106 to adjust a distance between the appendages 102, 104 using the linear actuator 112. A lateral motion stabilizer 108 and stabilizing rod 110 can be coupled to the moving appendage and the lateral ball screw 106 to ensure smooth movement of the appendage during distance adjustment. In the embodiment of the robotic gripper depicted in FIGS. 1A-2C, the belt-drive finger 104 is actuated using a lateral motor 114 with a belt-driven gear, which is coupled to the linear actuator 112 to move the cable-driven finger 102 along the lateral ball screw 106. However, the linear actuator can also be a separate element from the motor/gear 114, for example, to permit independent actuation of the belt-drive finger 104 and the adjustment of the distance between the appendages. In some embodiments, each appendage may be coupled to a respective linear actuator and/or lateral ball screw to independently move the appendages for distance adjustment. In some embodiments, the linear actuator 112, the motors 114, 124 and any other actuator/motor can each be a Dynamixel™ MX-32 or MX-64 motor.

The robotic gripper can comprise a plurality of sensors configured to capture sensor data for use in performing and evaluating gripping operation. As shown in FIGS. 1A-2C, the sensors can comprise a neuromorphic event camera 120 and an RGB-D camera 118. The cameras 118, 120 can be arranged to monitor the appendages 102, 104, objects, and environment within their fields of view. The neuromorphic camera 120 can provide event frames and/or streams which can capture dynamic changes, for example during close interactions between the appendages 102, 104 with the object. In particular, the data from the neuromorphic camera 120 can provide high-speed visual feedback. The RGB-D camera 118 may be a video or image camera and/or a RGB camera coupled to a depth sensor. The RGB-D camera 118 can offer a wide view for detecting objects from a distance and during close interactions. The RGB-D camera 118 can generate image or video data of the object and the appendages 102, 104, which can be overlayed or augmented with depth information. In particular, the RGB-D camera 118 can capture RGB frames for object identification and monitoring of the kinematics of the appendages 102, 104 (e.g. by tracking the displacement/movement of the markers 116) as well as depth frames for spatial and geometric context, as described further herein. The cameras 118, 120 can enable inference of tactile and vision information for performing complex manipulations and to robustly grasp non-standard objects. The cameras 118, 120 can also capture static and dynamic changes in close and distant proximity, with data in microseconds to seconds. Specifically, data from the cameras 118, 120 can be used to perform, monitor, and evaluate the gripping operation, as described further herein. In one embodiment, the cameras 120, 118 can respectively be a DAVIS™ 346 neuromorphic camera, and a D435 Realsense™ camera.

The various components of the robotic gripper 100 can be housed or coupled to a chassis or support frame. For example, the chassis can house the motors 112, 114, 124 and other components such as the lateral ball screw 106, lateral motion stabilizer 108 and stabilizing rod 110. The appendages 102, 104 may extend from an outer surface of the chassis. A microcontroller 126 can also be housed inside the chassis or coupled to the frame thereof (e.g. the outer surface of the chassis, as shown in FIG. 2A). The cameras 118, 120 may be arranged outside of the chassis and coupled thereto using one or more camera mounts 122. The chassis may be enclosed, for example using acrylic panels, as depicted in FIGS. 2A-2C. In some embodiments, the chassis and interconnecting components may be 3D printed, for example using model resin.

The microcontroller 126, as shown in FIG. 2A, can be used to operate the robotic gripper 100. For example, the microcontroller 126 can comprise one or more processors/processing units and can actuate the motors 112, 114, 124 to operate the appendages 102, 104 to perform the gripping operation. In some embodiments, the microcontroller 126 can process sensor data such as data from the cameras 118, 120 as well as other received data to perform, monitor, and evaluate the gripping operation, as described further herein. In some embodiments, the various data such as sensor data may be processed separately (e.g. not by the microcontroller 126) at one or more external processing units to process, control, monitor, and evaluate the gripping operation. Accordingly, the processing units may transmit control signals (e.g. for actuating the motors 112, 114, 124) based on the determined gripping operation (or evaluation/monitoring thereof) to the microcontroller 126 such that the microcontroller 126 is only used for gripper operation (e.g. motor actuation). For example, as depicted in FIG. 2A, the microcontroller 126 can be an Arduino™ control system.

As described above and shown in FIG. 2D, the robotic gripper 100 can utilize the cable-driven linear actuator 112 to contract the cable-driven finger 102, which sits on a ball screw mechanism 128 (and comprising the stabilizer 108) and movable on the ball screw 106 for lateral movement. The output shaft of the actuator 112 is coupled to a belt, which rotates the ball screw 106 for the lateral movement of the finger 102. The curl of the finger 102 may be controlled independently of the lateral movement using the motor 124. This lateral adjustment capability can allow the robotic gripper 100 to modulate the distance between the fingers 102, 104. In some embodiments, the belt-driven finger 104 can be static and designed with weaker support to its grasping surface, allowing it to conform when pressed into an object. This conformity can increase the contact surface area, which scales with surface friction to maximize grasp reliability.

As a result of the arrangement of fingers 102, 104 as shown in FIGS. 2A-2D, the gripper 100 is capable of producing abducted grasps of the thumb. Of the 5 abducted thumb grasp configurations possible with 2 fingers, the gripper 100 can reproduce 4: palmar pinch, inferior pincer, tip, and ring. Most of these grasps can excel in precision as they occur at the tips of the fingers 102, 104. However, the ring grasp is an exception that emphasizes power over precision and can give the gripper 100 versatility in its choice of grasp.

As described further herein, the gripper 100 can also integrate advanced sensing capabilities, enabling it to visually perceive the deformation of its thumb. In particular, markers 116 are arranged along the side profile of the belt-driven finger 104. This feature can be used for evaluating the finger's proprioception, and consequently the state of its grasp.

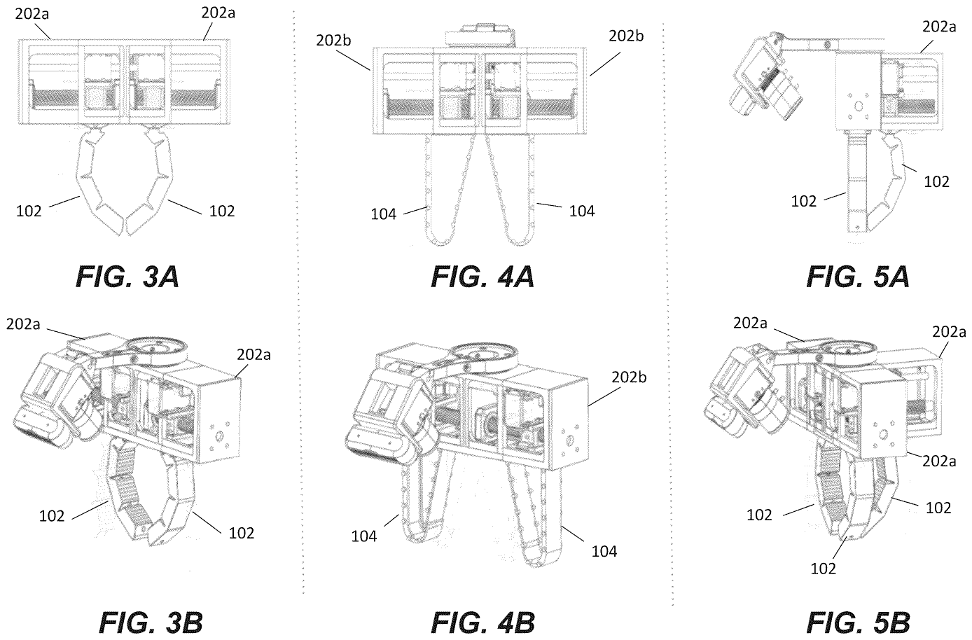

FIGS. 3A-5B depict alternative implementations of the robotic gripper of FIGS. 1A-2B. As shown in FIGS. 3A-5B, various combinations of appendages are possible. For example, FIGS. 3A and 3B depict an implementation of the robotic gripper 100 comprising two cable-driven fingers 102; FIGS. 4A and 4B depict an implementation of the robotic gripper 100 comprising two belt-driven fingers 104 for linear actuated gripping operation; and FIGS. 5A and 5B depict an implementation of the robotic gripper 100 comprising three cable-driven fingers 102, arranged in a triangle formation to improve gripping operation performance. As depicted in FIGS. 3A-5B, each appendage may be implemented using a respective component and may correspond to a respective modular and independent compartment. For example, each cable-driven fingers 102 can be implemented using a modular cable finger compartment 202a and each belt-driven finger 104 can be implemented using a modular belt finger compartment 202b. Further, to improve modularity and ease of production/use, the compartments of the same type (e.g. corresponding to the same type of appendage) may be identical. Each compartment may comprise the respective appendage extending from an outer frame thereof, motors for actuating the respective appendage and a linear actuator for adjusting a distance to another appendage, as described above. The modularity of the compartment design can allow the compartments to be coupled together to form an overall chassis having multiple appendages as the robotic gripper. Accordingly, the robotic gripper can be highly modular, scalable, and compact, facilitating robust grasping and complex manipulation under various constraints

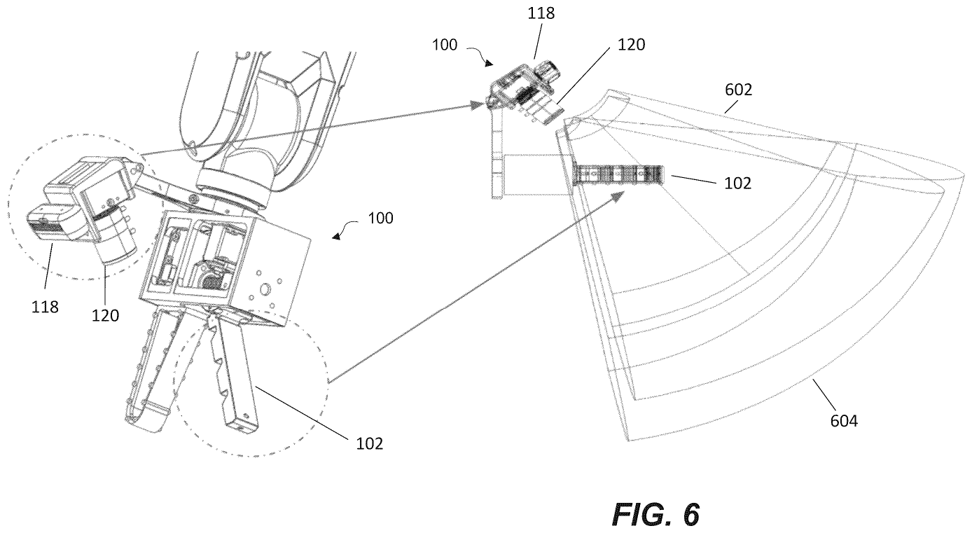

FIG. 6 depicts the fields of view for the cameras 118, 120. The RGB-D camera 118 can capture sensor data such as RGB and depth frames within a field of view 602 and the neuromorphic event camera 120 can capture sensor data such as event frames and streams within a field of view 604. As depicted in FIG. 6, the cameras 118, 120 are arranged to capture the activities of the appendages, object (e.g. target of griping operation), and the environment.

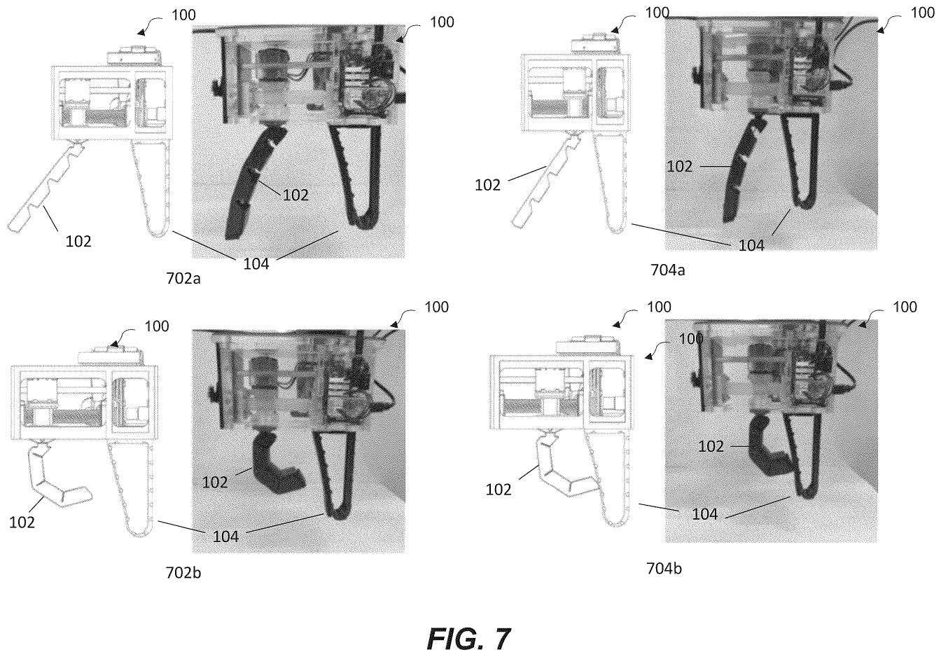

FIG. 7 depicts opening and closing (e.g. performing gripping operation) of the robotic gripper 100. 702a and 702b respectively shows the maximum and minimum separation distances between free ends of the appendages 102, 104, corresponding to the maximum and minimum size of an object for performing gripping operation at maximum distance (at the secured end) between the appendages 102, 104. 704a and 704b respectively shows the maximum and minimum separation distances between free ends of the appendages 102, 104, corresponding to the maximum size of an object for performing gripping operation at minimum distance (at the secured end) between the appendages 102, 104. As shown in 704b, the appendages 102, 104 can contact one another during gripping operation such that even small objects can be a target for gripping operation. It should be also noted that the distance between the appendages at the secure end can be adjusted based on the object and the separation between free ends of the appendages can change (e.g. decrease) as gripping operation is being performed.

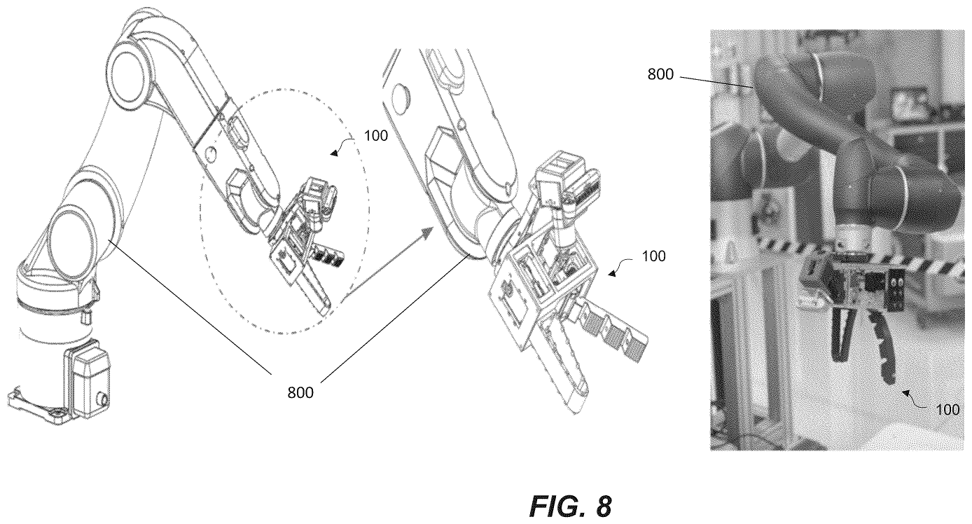

FIG. 8 depicts the integration of the robotic gripper 100 with a robotic arm 800, forming a robotic manipulator for use in various application. The robotic arm 800 can extend the range of motion and the area of operation of the robotic gripper 100.

As described above, the RGB-D camera 118 can capture visual and depth information, providing a broad view of the grasping area. It can also track markers 116 on the finger 104 to monitor its shape during operation. The neuromorphic camera 120 can deliver fast feedback on nearby interactions, allowing the gripper 100 to react quickly to changes in the environment. These visual sensors can complement each other, with the neuromorphic camera 120 addressing the RGB-D camera 118's limitations in low-light conditions. However, when operating them simultaneously, their signals can create significant noise in the event feed. To address this, the gripper 100, in particular the microcontroller 126, can alternate between the camera 118, 120 at any given moment. This setup can support real-time decision-making, enhancing the gripper's performance in dynamic tests like enduring external disturbances.

The grasp success prediction algorithm as described further herein can operate in real-time, processing data from the camera 118, 120. The RGB data from the camera 118 provides visual feedback on the gripper's alignment with a target grasping object, while the depth data from the camera 118 estimates the object's pose relative to the gripper 100. The neuromorphic camera 120, with its high temporal resolution, can capture rapid changes in the grasping scene, such as object movement or slip events. By fusing these data, the gripper 100 can construct a comprehensive understanding of the grasp conditions, enabling it to predict grasp success with high accuracy. This multimodal approach can significantly enhance the reliability of the gripper 100, particularly when handling objects with complex geometries or in environments with variable lighting and occlusion.

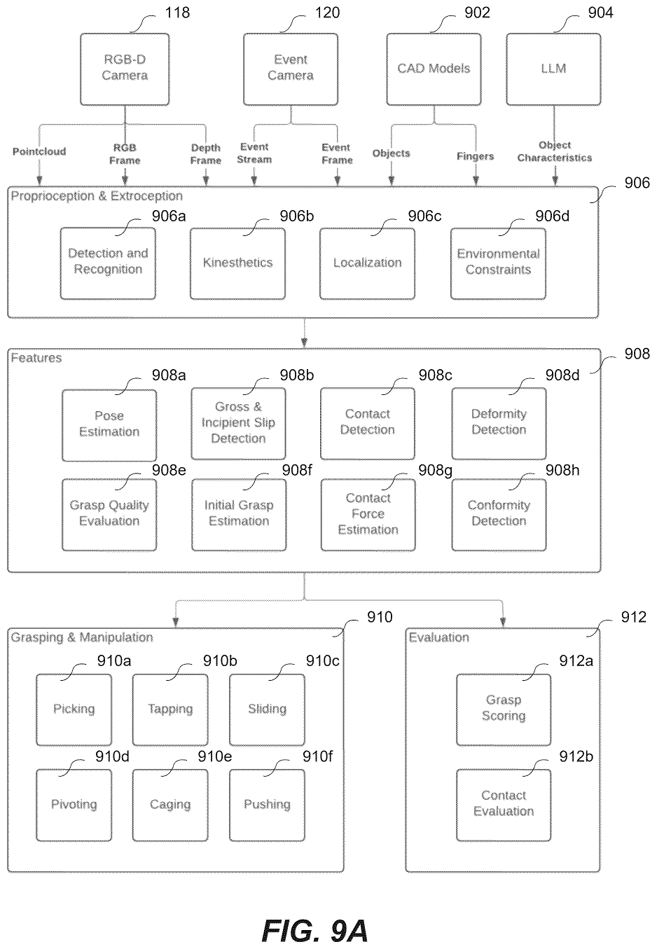

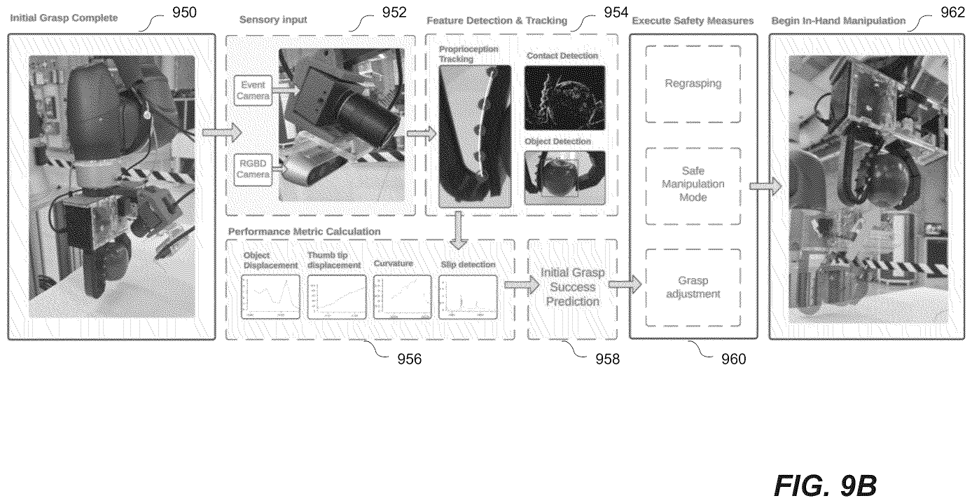

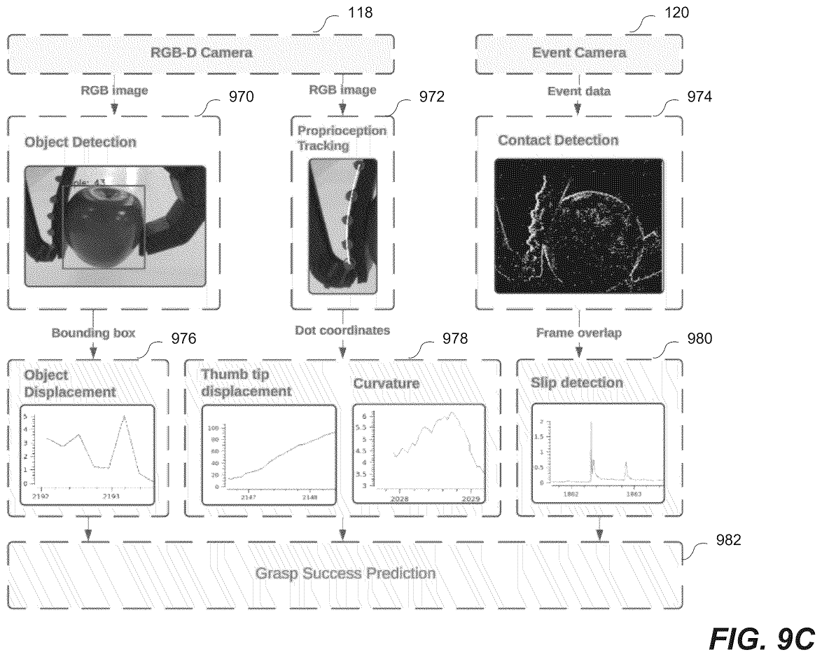

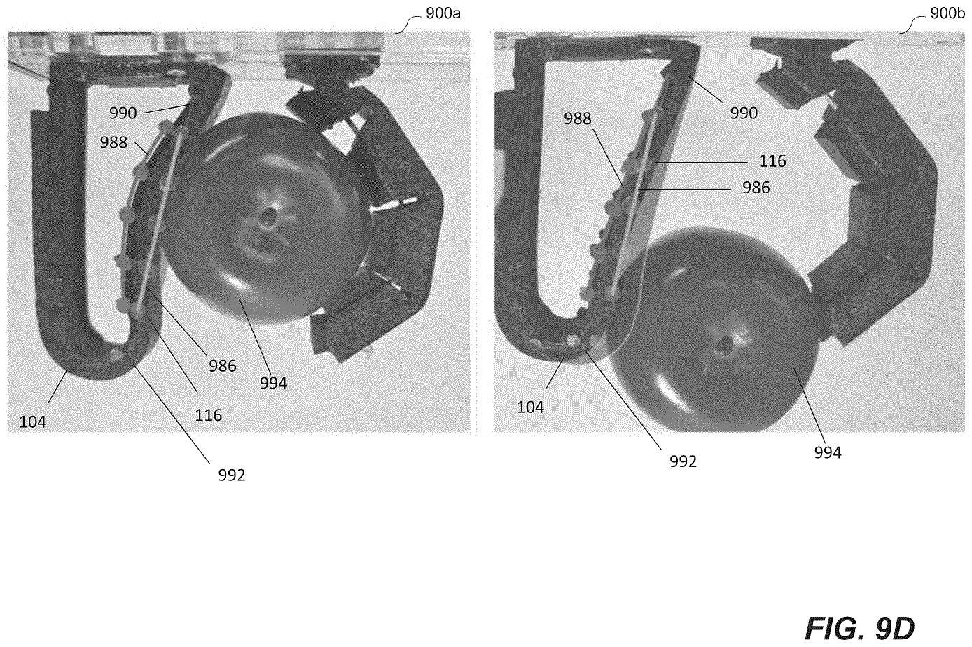

FIG. 9A depict a flow diagram of various data which can be processed, for example by the microcontroller 126, to perform, monitor, and evaluate the gripping operation. In some embodiments, a large language model (LLM) 904 or another type of neural network can be communicatively coupled to the robotic gripper 100 (e.g. microcontroller 126) to provide data for use in performing, monitoring, and evaluating the gripping operation. Similarly, 3D representations such as CAD models 902 can also be provided as data to or for use by the robotic gripper 100 (e.g. microcontroller 126). The 3D representations can be generated, updated, processed etc. by the robotic gripper 100 itself (e.g. microcontroller 126) or external processing units, which can be transmitted to the microcontroller 126. The CAD models 902, LLM 904 (or data therefrom) as well as sensor data from the cameras 118, 120 can be used for proprioception and/or exteroception (906) such as performing detection and recognition 906a, kinesthetics 906b, localization 906c, and constraint processing 906d. The proprioception and/or exteroception functionalities 906 can be used for various feature extraction or functionalities 908 of the robotic gripper 100, such as pose estimation 908a, gross and incipient slip detection 908b, contact detection 908c, deformity detection 908d, grasp quality evaluation 908e, initial grasp estimation 908f, contact force estimation 908g, and conformity detection 908h. Correspondingly, information determined by the functionalities 908 can be used to perform gripping operation 910 as well as gripping operation evaluation 912. Gripping operation 910 can include performing picking 912a, tapping 912b, sliding 912c, pivoting 912d, caging 912e, pushing 912f, grasping, holding, etc. on an object. Gripping operation evaluation 912 can comprise grasp scoring 912a corresponding to a stability and quality of the gripping operation and contact evaluation 912b corresponding to a level and quality of contact between the appendages and the object during gripping operation. That is, proprioception and exteroception data 908 from the appendages, objects, and environment are used to extract features 908 for gripping operation 910 and evaluations thereof (912). In particular, the proprioception and exteroception data 908 comprising the data from the CAD models 902, LLM 904 and the cameras 188, 120 can be processed by a processor (e.g. the microcontroller 126) implemented as a vision-based perception module.

As depicted in FIG. 9A, the RGB-D camera 118 can captures RGB frames that can be used for: object detection and recognition (906a), including real-time tracking of the object during gripping operation as well as monitoring of the kinematics of the appendages (906b), providing insights into the motion and positioning of the robotic gripper (e.g. appendages) during griping operation. The RGB-D camera can also produce depth frames that can be used for spatial localization (906c) to determine the relative positions of the object, robotic gripper (e.g. appendages), and surrounding environment. The depth frames can also be used for or as supplement to creation of point clouds for accurate 3D geometry processing of both the object and appendages to perform gripping operation 910. The RGB-D camera 118 can also be used to identify environmental constraints 906c, which the gripping operation must account for (e.g. restricting potential appendage movements). As such, data from the RGB-D camera 118 can collectively track interactions involving the appendages, objects, and the environment, ensuring precise spatial and relational mapping critical for adaptive control.

In particular, the RGB-D camera 118 can provide continuous feedback on finger kinematics 906b by observing the displacements of the markers 116 along the belt-driven finger 104. The finger kinematics 906b can ensure precise alignment of the appendages (e.g. with the object) and enable real-time adjustment for robust object engagement. Finger kinematics 906b can also provide positional insights by tracking marker movement to analyze the dynamic motion of the appendages during interactions with the object as well as for conformity information or detection 908h, which can indicate how well the appendages adapt to and enclose the object's shape, which is a critical factor for stable gripping operation.

It should be noted that estimating contact force using the RGB-D camera 118 can rely on indirect inference methods. For example, the RGB-D camera 118 cannot directly measure forces. Instead, visual cues such as deformation, displacement, and other effects resulting from object-appendage interactions can be analyzed. For example, when an object is grasped, its surface and the appendages may deform due to applied forces. These deformation patterns can be captured by the RGB-D camera 118 as changes in shape or texture. Using known material properties (e.g., elasticity and stiffness from the LLM 904), these observed deformations can be mapped to estimated contact forces, for example using an algorithm or neural network. Ground truth force measurements from force/torque sensors can also be used to validate and enhance the estimation process.

The neuromorphic camera 120 can records high-speed event streams and frames to detect subtle and rapid changes, for example at the points of contact between the appendages and the object (e.g. for use in contact detection 908c). In particular, the event streams and frames can be used to detect incipient slip (908b) by observing early indications of object movement relative to the appendages, which can be identified by observing slight shifts on the appendage surfaces or the object's exterior as well as gross slip (908b) by detecting significant movement or loss of grasp between the appendages and the object by analyzing the displacement between the object and the appendages. Data from the neuromorphic camera 120 can also be used to detect motion anomalies by capturing irregular dynamics during gripping operation, such as unexpected changes in object behaviour. Data from the neuromorphic camera 120 can focus on the exterior of the appendages and the interacting object, ensuring a comprehensive analysis of the manipulation dynamics. In other words, observations from the neuromorphic camera 120 focus on appendage-object interfaces, providing granular data for refining quality and stability of gripping operation.

Additionally, depth data from the RGB-D camera 118 and event-based data from the neuromorphic camera 120 can be utilized to track surface or appendage displacements. The magnitude of these displacements correlates with applied forces, enabling a force-contact relationship to be established. Machine learning models trained on datasets combining visual changes (deformation, displacement) and force/torque measurements can be used to predict contact forces. During operation, these trained models can use RGB images, depth data, and event-based data to estimate contact forces, eliminating the need for tactile sensors.

The CAD models 902 can provide reference 3D geometries for accurate alignment and pose registration (908a) of the appendages to ensure that their spatial arrangement matches the intended gripping operation as well as the objects themselves to allow for the precise determination of their orientation and positioning relative to the appendages. This dual registration can support robust gripping operation planning by ensuring the manipulation system adapts to the shape and orientation of both the object and appendages.

The LLM 904 is communicatively coupled to the robotic gripper 100 and can act as a dynamic knowledge base to provide object-specific properties based on its classification or name. In particular, the LLM 904 can provide data such as real-time recommendations comprising: object deformability (908d) to guides the selection of grasp forces, ensuring adaptability to deformability of the object (e.g. soft or rigid); object size and weight for use in analysis of grip stability (908e) and manipulator trajectories; and object material properties (e.g. surface friction, elasticity, texture, etc.) for use in adaptive force and contact point selection (908g) for gripping operation. As such, it is possible to achieve enhanced decision-making by querying the LLM 904 for material-specific insights, such that the robotic gripper can adapt dynamically to a wide variety of objects, ensuring robust grasping and manipulation.

Data from the LLM 904 can also be used, in combination with sensor data from cameras 118, 120, for grasp scoring 912a and contact evaluation 912b, forming gripping operation evaluation 912. In particular, visual data from the RGB-D camera 118 can be combined with finger kinematics data 906b to estimate initial contact points. The contact points, alongside the object's shape, can be used to construct a convex hull to capture the interaction geometry between the appendage and the object. Traditional grasp quality metrics, such as grasp wrench space analysis or force closure, can also be applied to evaluate the quality of the grasp (912a). Further, the event frames and streams from the neuromorphic camera 120 can be utilized for grasp scoring 912a and contact evaluation 912b in an analogous manner. Specifically, neuromorphic camera 120 can provide high-speed event-based streams, which can enable detection of fine-grained motion changes during gripping operation to allow for rapid, real-time calculation of grasp scoring 912a by capturing miniature changes in object or appendage behavior. These event-based measures can enable quick responses to incipient slip or destabilizing forces, improving the robotic gripper's ability to adapt to dynamic scenarios. Moreover, these visually perceived grasp quality measures can represent novel methodologies for determining grasp robustness, leveraging the spatial arrangement and contact dynamics observed visually.

FIG. 9B depicts a process for grasping a target object using the gripper 100 and the process performed by the gripper 100 to evaluate the grasp. In the current embodiment, the object is to be grasped by the fingers 102, 104 in order to move the object.

At 950, an object is grasped by the gripper 100 using the fingers 102, 104. At 952, sensor data as described above from the cameras 118, 120 are received. The sensor data is continuously captured and processed at 954 to perform object detection and tracking, as described above and further herein. Finger proprioception and object detection can be tracked and performed using the 116 and the visual data from the RGB-D camera 118, for example in combination with the LLM 904. Additionally, contact detection between the fingers 102, 104 and the object can be performed, for example using sensor data from the neuromorphic camera 120. At 956, the sensor data can be further processed and analyzed to evaluate various grasping parameters such as object displacement, fingertip changes/displacements (for the fingers 102, 104), curvatures for the fingers 102, 104, and to detect object slippage. The grasping parameters are processed at 958. Based on the parameters, an initial grasping evaluation can be determined based on the quality of the grasp by the fingers 102, 104 on the object. For example, a score can be calculated with the quality of grasp corresponding to a respective range of scores.

At 960, the fingers 102, 104 are controlled based on the grasping evaluation, for example to perform one of a plurality of grasping maneuvers. In particular, if the grasp is evaluated as a failure, for example where the evaluation of the parameters shows that the fingers 102, 104 did not successfully grasp the object, the gripper 100 can control the fingers 102, 104 to (release and) regrasp the object. If the grasp is evaluated as weak, bad, or inadequate, for example where the evaluation of the parameters shows that fingers 102, 104 have a weak grasp, the fingers 102, 104 can be controlled to adjust the grasp on the object to improve the grasp. If the grasp is evaluated as good or strong, the gripper 100 can then perform object manipulation, for example by moving the object at 962. That is, once the grasp is satisfactory, the object manipulation at 962 can be performed.

In some embodiments, grasping evaluation comprises evaluation of conformity, deformity, and slippage as parameters. As shown in FIG. 9C, RGB image data from the RGB-D camera 118 can be used for object detection at 970, for example using a bounding box within a region of interest. The displacement of the object can then be determined at 976 therefrom. The same image data can also be used for proprioception tracking at 972 using the markers 116, for example by evaluating dot coordinates of the markers. At 978, the tip displacement, for example corresponding to the change in position on the free end of the finger 104, can be determined. Similarly, the curvature of finger 104 and/or finger 102 can be determined at 978. The sensor data from the neuromorphic camera 120 can be used for contact detection at 974. For example, by evaluating frame overlap, slippage of the object can be detected and monitored at 980. The parameters evaluated at 976, 978, and 980 can be used to evaluate the grasp at 982.

In the current embodiment, conformity is a quantitative measure of how well the gripper 100, in particular the finger 104, conforms to an object's surface. In some embodiments, conformity can be output as a score. In the current embodiment, conformity can be expressed as a heuristic percentage, for example calculated using a curvature formula. In particular, the formula can involve a function of a line (f (x)) passing through the proprioceptive markers 116. The general form for the equation to calculate conformity is shown below:

$$κ ( x ) max = max ( \frac{\vert {f}^{″} ( x ) \vert}{{( 1 + {( {f}^{′} ( x ) )}^{2} )}^{3 / 2}} ) .$$

As described above, the markers 116 can serve as reference points for, thereby enabling precise tracking of the finger 104's curvature during grasping. That is due to the deformable nature of the finger material, as the finger 104 contacts and grasps the object, the finger can curve and deform along its longitudinal axis as the object presses into the finger 104, conforming to the object. Therefore, the conformity metric can be used to provide a reliable indication of the surface deformation of the finger 104 in relation to the object. A higher conformity value can indicate greater contact area, which hypothetically correlates with a more stable grasp. This process can be performed in real-time using Algorithm 1 below, allowing the gripper 100 to continuously monitor the gripper's interaction with the object. By quantifying conformity, the gripper 100 can assess whether it has achieved sufficient contact with the object, which is essential for ensuring grasp stability.

Algorithm 1 Conformity feature calculation

1: function CONFORM_DETECTION

| | |
|---|---|
| 2: circles ← get_circles() | [symbol] Extract coordinates of circle centers |
| 3: line ← fit_polynomial(circles) | [symbol] Fit 3rd degree polynomial |
| 4: x_dense ← linspace(line) | [symbol] Generate dense x points |
| 5: y_dense ← polynomial(x_dense) | [symbol] Generate dense y points |
| 6: first_deriv ← derivative(polynomial) | [symbol] Compute curvature |
| 7: second_deriv ← derivative(first_deriv) | |

$8 : curvature ← \frac{\vert second\_deriv ( x\_dense ) \vert}{{( 1 + {( first\_deriv ( x\_dense ) )}^{2} )}^{3 / 2}}$
9: max _curvature ← max(curvature)

As shown in Algorithm 1, the coordinates of the circles can be used as to fit a virtual line using the center coordinates, which in the current embodiment is a 3^{rd} degree polynomial. By obtaining the dense x and y points from the fitted line, the conformity can be calculated as the curvature (e.g., in heuristic percentage) based on the line and derivative thereof.

FIG. 9D depicts the fingers 102, 104 grasping an apple 994 as the object. In FIG. 9D, line 986 represents the virtual line described above formed by the markers 116 when the finger 104 is at rest and line 988 represents the same virtual line when the finger 104 is deformed as it performs grasping. As shown in 900a, a conformity variation exists for the finger 104 before grasping (line 986) and after grasping (line 988). In 900a, there is a high conformity for the finger 104 in relation to the rest position.

In the current embodiment, deformity data quantifies the total deformation. Referring to FIG. 9D, deformity is based on a displacement variation of the finger 104 between a base portion 990 proximal to the chassis and a tip portion 992 at the free end. In some embodiments, the base portion 990 and tip portion 992 are defined by the first and last of the markers 116. Similarity to conformity, deformity is based on a curvature or displacement of the object side of the finger 104 inwards as grasping is performed. Deformity can be evaluated as a score and is expressed as a heuristic percentage in the current embodiment. As shown in FIG. 9D, deformity can be derived by analyzing the displacement of the proprioceptive markers 116 as the finger 104 deforms under load, corresponding to an apple 994 as the object in FIG. 9D. Deformity data can serve two primary purposes: first, it allows the gripper 100 to ensure that the gripper 100 does not exert excessive force that could damage the fingers 104 or the object. Second, deformity can provide insights into the spatial distribution of the object within the grasp, helping the gripper 100 determine the type of grasp that is being applied.

In the current embodiment, the calculation of deformity involves comparing the gradients of the lines 986 and 988. In particular, line 986 represents the virtual line described above formed by the markers 116 when the finger 104 is at rest and line 988 represents the same virtual line when the finger 104 is deformed as it performs grasping. The calculation can be performed in real-time, for example by the microcontroller 126, enabling the gripper 100 to detect changes in deformation during grasping and manipulation and to subsequently apply corrections. For instance, if the deformity value exceeds a predefined threshold, the gripper 100 may infer that the gripper is applying too much force, prompting it to reduce the grasp force. By combining deformity data with conformity data, the gripper 100 can achieve a more nuanced understanding of the grasp conditions.

Referring to 900b of FIG. 9D, a deformity variation exists for the finger 104 before grasping (line 986) and after grasping (line 988). In 900b, there is a high deformity for the finger 104 in relation to the rest position as the tip portion 992 deviates significantly from the rest position.

In the current embodiment, slippage or slip detection can be evaluated to ensure grasp stability, particularly when handling objects with smooth or slippery surfaces. The proposed gripper 100 can leverage the high temporal resolution of the neuromorphic camera 120 to detect slip events with microsecond-level latency. In particular, the neuromorphic camera 120 can capture changes in the grasping scene as a series of discrete events, each representing a change in brightness at a specific pixel location. This event-based approach can enable the gripper 100 to detect rapid movements, such as slips, with minimal delay.

In the current embodiment, a reference event frame from the neuromorphic camera 120 captured during the final moment of grasping can be compared to subsequently captured frames. Algorithm 2 can be performed by the gripper 100 (e.g., microcontroller 126) to evaluate slippage.

Algorithm 2 Slip detection

1: function GET_SLIP(image_data, ref_frame)
2: live_frame_gray ← convert_to_grayscale(image_data)
3: ref_frame_gray ← convert_to_grayscale(ref_frame)

| | |
|---|---|
| 4: intersect ← pixelwise_and(live_frame_gray, ref_frame_gray) | [symbol] Compute the pixel-wise |

AND to find overlapping features
5: ref_avg ← average_pixel_value(ref_frame_gray)
6: intersect_avg ← average_pixel_value(intersect)
$7 : slip\_feature ← ( \frac{intersect\_avg}{ref\_avg} ) \times 100 ⊳ Compute slip feature as a percentage$
8: return slip_feature

As shown in Algorithm 2, a bitwise AND operation (known as pixelwise AND when applied to image data) can be performed between the reference frame and a subsequent or current frame captured by the neuromorphic camera 120. This is followed by frame averaging to compute a scalar value representing the magnitude of events within the region of interest (ROI) that shows the grasping of the object and the fingers 102, 104. That is, the ROI is a snapshot encompassing the object and fingers at the last moments of a grasp. Slippage can then be computed as a percentage from the average pixel values of the reference and current frames. This can be mathematically computed by quantifying the overlap of live (e.g., current) event data from the neuromorphic camera 120 within the predetermined ROI (e.g., at line 4). In order to use this quantified overlap, the event overlap is then computed as a percentage of the ROI (e.g., at line 7). If the slippage value corresponding to the magnitude of events exceeds a threshold within the ROI, the gripper 100 can then infer that slip is occurring and subsequently take corrective action. Such cases can involve adjusting (e.g., increasing/decreasing) the grasp force or adjusting the finger positions to stabilize the object. This low-latency capability can enable the gripper 100 to react to slip events almost instantaneously, reducing the risk of dropping the object.

Robotic grasping in unstructured environments can present significant challenges due to uncertainties in OPE, environmental variability, and the inherent compliance of soft grippers. Traditional rigid grippers often lack the adaptability and sensory feedback required to handle these challenges effectively, leading to unreliable grasps and increased risk of failure during manipulation. Accordingly, as described above, the parameters of conformity, deformity, and slippage can then be used to evaluate the grasping of the object. The grasp can be evaluated as a score or a likelihood of successful grasp by leveraging multimodal sensing and feature tracking, as described above.

The grasp evaluation can be used to evaluate the robustness of a grasp before manipulation begins, thereby allowing the gripper 100 to initiate safety measures to decrease the probability of failure. This capability can reduce the inherent uncertainties caused by GPE, OPE, and the compliance of the soft gripper using heuristic or model-based systems. Traditional rigid grippers often lack the ability to provide feedback on grasp success, let alone quantify grasp success rate. In contrast, the gripper 100 may leverage visual features to classify grasps into a plurality of ratings. In the current embodiments, four categories of robust, good, bad, or failed grasp are used. This classification is based on conformity, deformity, and slip detection. By evaluating these features, the gripper 100 can identify poor grasps prior to manipulation, enabling the robot to take corrective actions such as regrasping or grasp regulation. An example classification is shown below in Algorithm 3.

Algorithm 3 Heuristic grasp success prediction

| | |
|---|---|
| 1: | function GET_SUCCESS_PREDICTION(curvature, deformity, |
| | translation, slip) |
| 2: | if NOT object_is_detected then |
| 3: | return “Failure” |
| 4: | if slip_detected( ) OR out_range(conformity, deformity) then |
| 5: | if deformity > deformity_limit then |
| 6: | perform_motor_correction( ) |
| 7: | return “Bad” |
| 8: | if in_good_range(conformity, deformity) AND no_slip(slip) |
| | then |
| 9: | return “Good” |
| 10: | if in_robust_range(conformity, deformity) AND no_slip(slip) |
| | then |
| 11: | return “Robust” |

As shown in Algorithm 3, if the object is not detected, for example in the ROI, the grasp can be evaluated as a failure. For a failed grasp, the gripper 100 can then perform regrasping. If slippage is detected based on the threshold slippage value, the grasp can be evaluated as a weak or bad grasp. Alternatively, if conformity and/or deformity exceeds a predetermined satisfactory range, the grasp can also be evaluated as bad. When the grasp is evaluated as bad, the gripper 100 can then perform corrective maneuvers such as regrasping. Further, if deformity also exceeds a threshold value, the corrective maneuvers can also be performed. These maneuvers can include shifting of the object along the fingers 102, 104 and applying reduced/additional force on the object. If no slip is detected and the conformity and/or deformity is within the satisfactory range, the grasp can be evaluated as good. If no slip is detected and the conformity and/or deformity is within a more preferred range within the satisfactory range, the grasp can be evaluated as robust. For good and robust grasps, the gripper 100 can proceed to performing object manipulation such as object movement.

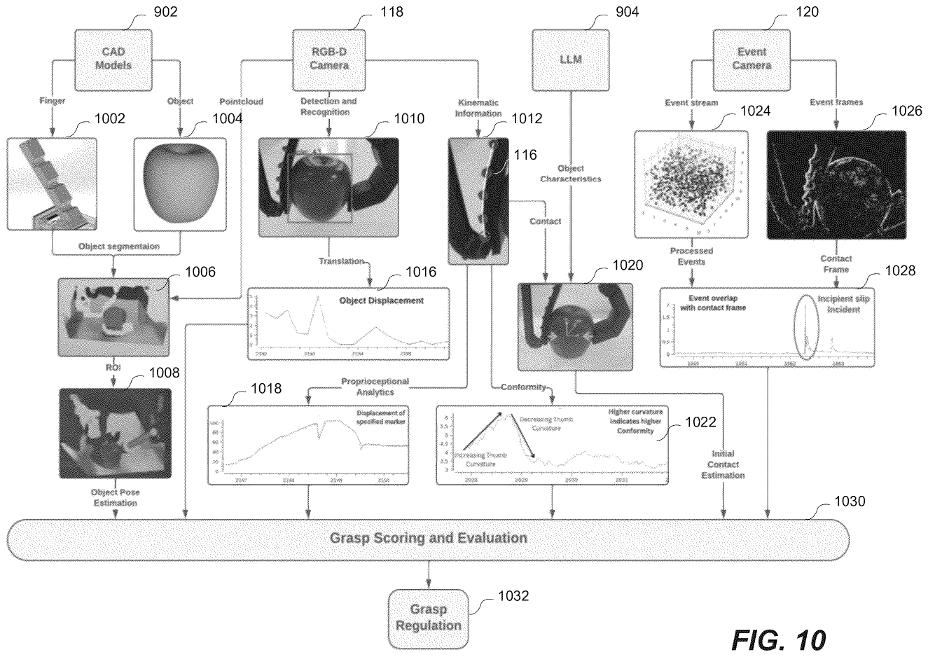

FIG. 10 depicts the use of sensor data for evaluation of the gripping operation (1030). The evaluation of the gripping operation can be used to regulate, monitor, and adjust the gripping operation (1032). In particular, a decision module (e.g. the microcontroller 126) can classify the quality of the gripping operation grasps as firm, stable, or failure, based on metrics such as slip, force distribution, and contact conformity. Further, the quality of the gripping operation may be evaluated using a scoring system to enable adaptive responses to changes during the gripping operation. In the current embodiment, gripping operation is grasping of an object.

The gripping operation can be a multi-modal sensing and execution process, which can be broken into three phases, described herein with reference to a pick-and-place task.

In a first pre-grasp phase, pose estimation 1008 can be performed. CAD models 902 comprising appendage model 1002 and object model 1004 can be registered or combined with point cloud data generated using the RGB-D camera 118 to extract 6-degree-of-freedom (DOF) poses at 1008. The registration process can include applying one or more 3D filters to remove unwanted points from the scene, and use of multiple feature descriptors (e.g. from the LLM 904) to estimate the feature points of both the model of the object and the actual object in the scene. Once sufficient key points are obtained, algorithms such as an initial and final alignment algorithms can be applied. Moreover, filters to track object motion and refine object pose estimates may be used. The registration pipeline can therefore provide a pose estimate of the given object from the real environment.

Further, object segmentation using the models 1002, 1004 can be used to segment the visual data from the RGB-D camera 118 to identify region of interest at 1006, corresponding to the object. For example, object detection models, implemented using one or more processors (e.g. the microcontroller 126) can generate 2D bounding boxes, which are converted into 3D boundaries for segmentation of the visual data for robust pose estimation of the graspable object in the actual scene.

Gripping operation planning can also be performed during the pre-grasp phase. Specifically, the registration of the 3D models 902 for the appendages and the object can support robust planning by ensuring the robotic gripper 100 adapts to the shape and orientation of both the object and appendages. Algorithms and planners (e.g. on the microcontroller 126) can be used to generate grasp hypotheses by combining pose data with CAD-based or learning-based grasp detection methods. Further, by combining data from the cameras 118, 120, LLM-provided properties, and CAD-based geometry, it is possible to identify optimal grasp points corresponding to suitable locations for contacting the object using the appendages.

In a second grasping phase corresponding to the execution of the gripping operation, object contact, and object conformity can be monitored. As described above, the neuromorphic camera 120 can capture event streams 1024 and event frames 1026, which can detect the physical overlap of the appendages and the object's surfaces to pinpoint precise moments of contact by detecting sudden pixel-level changes. Further, by processing events from event stream 1024 and contact frames from event frames 1026, it is possible to detect gross and incipient slip events at 1028. Specifically, event streams 1024 can be used to detect incipient slip and motion anomalies allowing real-time adjustment of grip forces to prevent failure.

The RGB-D camera 118 can capture data for use in tracking finger kinematics at 1012, for example by analyzing the displacement of markers 116 on the belt-driven appendage 104. The displacement can be used to determine conformity at 1022. For example, conformity and deformity detection at 1022 can form a part of proprioceptive sensing and can comprise an algorithm for curvature calculation (e.g. Hough circle detection and 2D Cartesian curvature) as well as deformation measurement at 1018, which can be added using marker displacement. As depicted at 1022, conformity can be shown as a function of the appendage curvature (e.g. of the belt-driven appendage 104), which can increase/decrease based on conformity, with higher curvature indicating higher conformity. Finger kinematics at 1012 can also be used for contact detection and slip detection at 1020. For example, thresholds, binarization and neighborhood search operations can be performed at 1020 to perform incipient and gross slip detection. To perform initial contact estimation, event brightness and motion frames may be analyzed for contact detection. Further, object properties (e.g. deformability) can be derived from the LLM 904, which can also guide adjustments to force (e.g. required applied force by the appendages) and positioning as well as in performing contact estimation such as initial contact point estimation. Additionally, visual data from the RGB-D camera 118 can be used for object detection and recognition at 1010, for example to identify the location of the object as well as the pose relative to the appendages. Once detected, the displacement of the object can be monitored and analyzed at 1016.

At a third post-grasp phase corresponding to the evaluation of the gripping operation, grasp score and quality can be analyzed at 1030, following the above described processes and information derived therefrom. As described above, the visually observed contact regions can be evaluated to construct a convex hull of the observed points to assess grasp stability (e.g. gripping operation). The quality of the gripping operation can also be evaluated under traditional metrics such as grasp wrench space analysis and force closure. Further, the data from the neuromorphic camera 120 can also enhance responsiveness to dynamic changes, enabling fast, iterative quality measures.

Specifically, during the post grasp phase, the quality of the gripping operation can be continuously evaluated by continuously monitoring the object's displacement and reorientation. The visual data (e.g. from the cameras 118, 120) can be used to estimate contact regions, which are approximated to 2D contact points for grasp quality assessment using grasp wrench space analysis. The gripping operation can be scored based on firmness, stability, and potential failure, ensuring a reliable grip throughout the manipulation process.

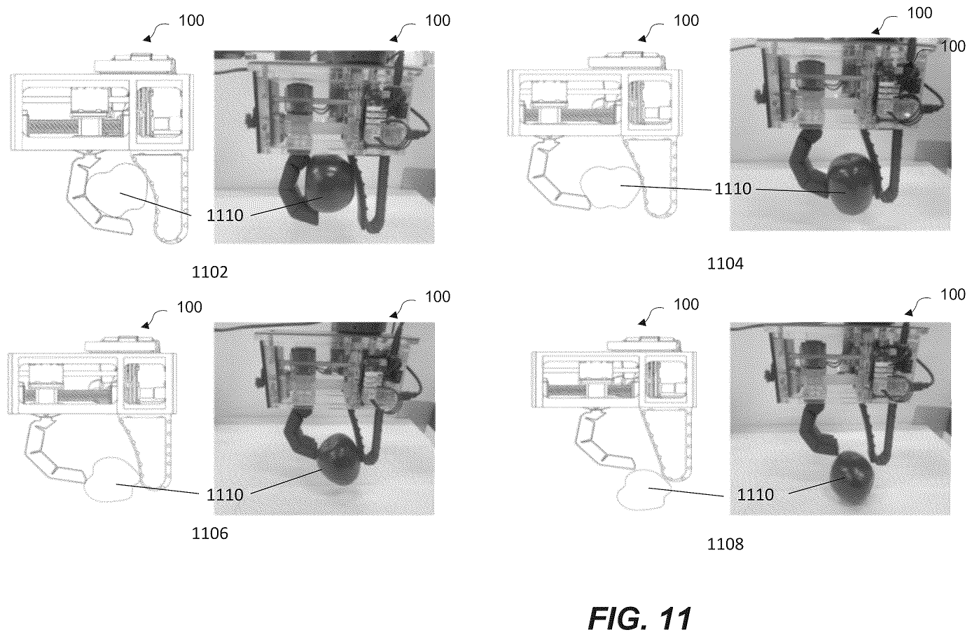

FIG. 11 depicts the evaluation of griping operation quality. As shown in FIG. 11, a gripping operation being a grasp is executed on an object 1110 by the robotic gripper 100. 1102 depicts a firm or robust grasp, where extensive contact regions and full finger conformity can be observed, which can ensure high stability. Visual data from the cameras 118, 120 can also be combined with force and kinematics observations, to confirm robust engagement with the object 1110. 1104 depicts a stable or good grasp, where sufficient contact regions supporting object retention during manipulation can be observed, though less robust than a firm grasp. 1106 depicts a weak or bad grasp, with less contact regions than a stable grasp. 1108 depicts a failed grasp (failure grasp), where there are insufficient contact points or where slip is detected, leading to potential loss of the object 1110. The failed grasp can be detected using event streams from the neuromorphic camera 120, and can prompt adjustment once detected to recover the object 1110.

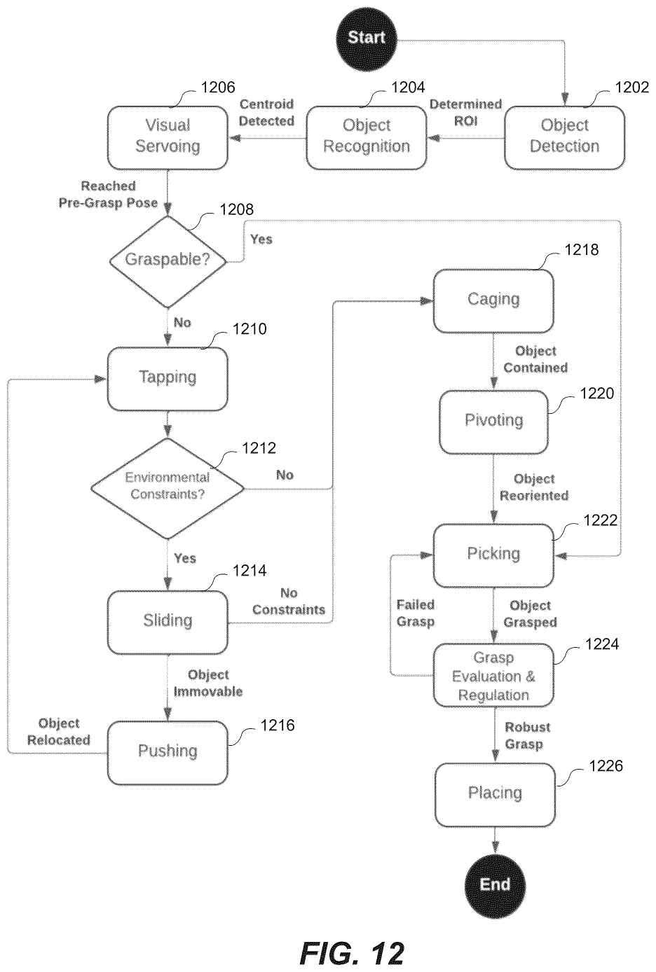

FIG. 12 depicts the process flow for performing a gripping operation. At 1202, the object serving as the target for the gripping operation is detected. In particular, detection and pose estimation can be performed using the cameras 118, 120 to detect and recognize the object in the scene at 1204, for example by determining a region of interest corresponding to the object. In particular, the visual data from the cameras 118, 120 can be used to detect the centroid of the object. The RGB-D camera 118 can provide RGB frames, depth frames, and point clouds, which are used to estimate the object's pose at 1206. By performing visual servoing at 1206, it is possible to evaluate whether the current pose is suitable for grasping. When the pre-grasp pose is reached, an initial grasp attempt can be made.

If the object is graspable (Yes at 1208), the robotic gripper 100 can execute the picking action at 1222 as the gripping operation. If the object is grasped, the grasp quality can be evaluated at 1224, for example in real-time using kinematic and sensory data. The robotic gripper 100 can also adjust appendage positions and forces based on the evaluation to improve and ensure grasp quality. If the grasp quality is poor (e.g. a failed grasp), picking operation can be executed again at 1222. Otherwise, if the grasp quality is sufficient, the object can be moved to a target location at 1226.

If the object is not graspable (No at 1208), for example at the current pose, reorientation may be performed. At 1210, tapping may be performed by the appendages (e.g. the belt-driven finger 104) as the gripping operation (e.g. additional gripping operation). Tapping can comprise making contact with the top surface of object to check for any environmental constraints that might obstruct movement. If environmental constraints are present (Yes at 1212), sliding may be performed as the gripping operation (e.g. additional gripping operation). Sliding can refer to the movement (e.g. sliding) of the object, for example to a more accessible position using appendages 102, 104, in the belt-driven finger 104. Alternatively or additionally, pushing at 1216 may be performed as the gripping operation (e.g. additional gripping operation), for example when the object is not movable by sliding. Pushing can refer to the movement of the object using the appendages 102, 104, in particular using the belt-driven finger 104. Pushing can also relocate the object to a non-obstructive environment. Once relocated, gripping operation can be resumed from tapping at 1210. It should be noted that sliding can be performed by contacting one or more appendages to a top surface of the object for movement while pushing can be performed by contacting the one or more appendages to a side surface of the object for movement.

Once the object is free from environmental constraints via sliding at 1214 or if there are no environmental constraints (No at 1212), caging can be performed as the gripping operation (e.g. additional gripping operation). Caging can refer to the use of the appendages 102, 104, in particular the cable-driven finger 102 to contain the box, securing it within the robotic gripper's appendages. At 1220, pivoting can be performed as the gripping operation (e.g. additional gripping operation). For example, once the object is contained, the object may be reoriented (e.g. pivoted) into a graspable pose using the appendages 102, 104. Once the box is reoriented, picking can be performed at 1222. It should be noted that the robotic gripper 100 can ensure that the grasp is firm and stable via evaluation at 1224 placing the object at 1226. Accordingly, the robotic gripper can handle complex manipulation tasks, incorporating multi-modal sensing and advanced actuation techniques. Further, the robotic gripper can autonomously adapt to various object poses and environmental constraints, and as such may be used for versatile and efficient manipulation in real-world applications.

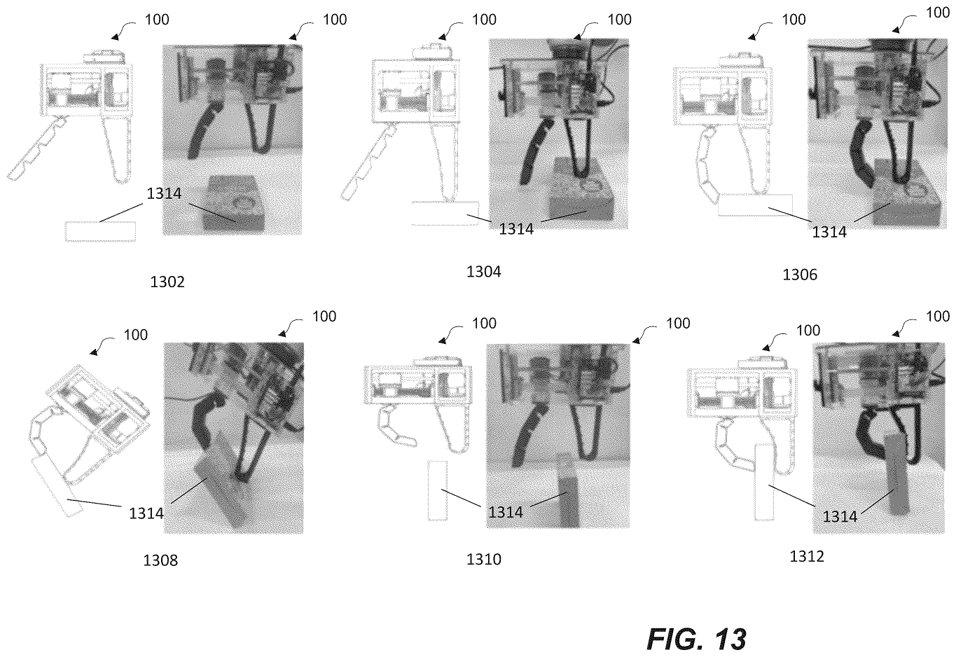

FIG. 13 depicts the execution of griping operations for grasping an object 1314 when the object 1314 is not initially graspable due to embodiment limitations. At 1302, grasp assessment is performed, followed by tapping at 1304, caging at 1306, pivoting at 1308, grasp (re-) assessment at 1310 and picking at 1312.

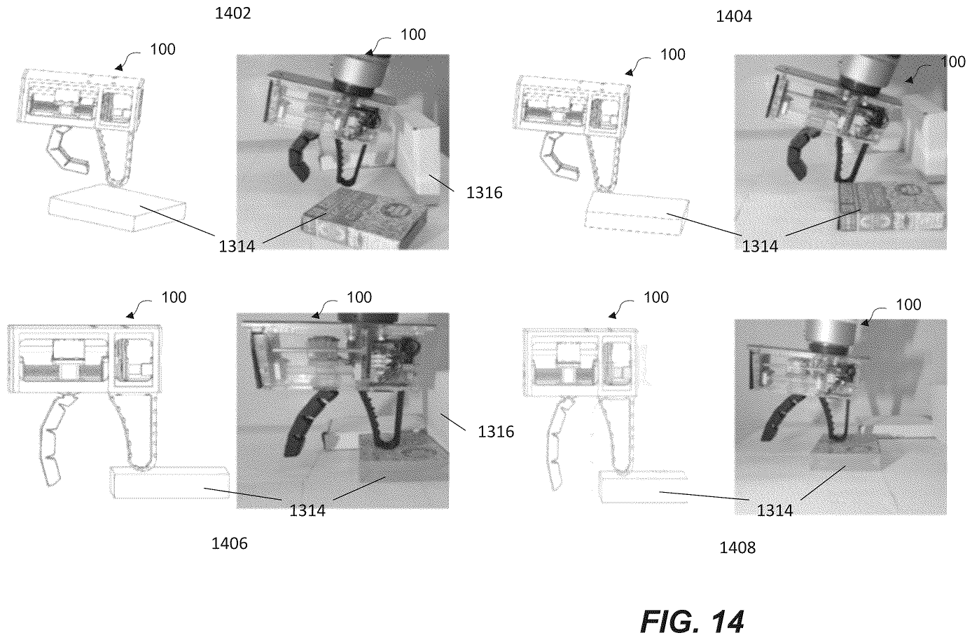

FIG. 14 depicts the execution of griping operations for grasping an object 1314 when the object 1314 is not initially graspable due to environmental constraints 1316. At 1402, the object 1314 is under environmental constraints 1316. At 1404, the robotic gripper executes pushing on the object 1314 to move it away from the environmental constraints 1316. Similarly, at 1406, the object 1314 is under environmental constraints 1316. At 1408, the robotic gripper executes sliding on the object 1314 to move it away from the environmental constraints 1316.

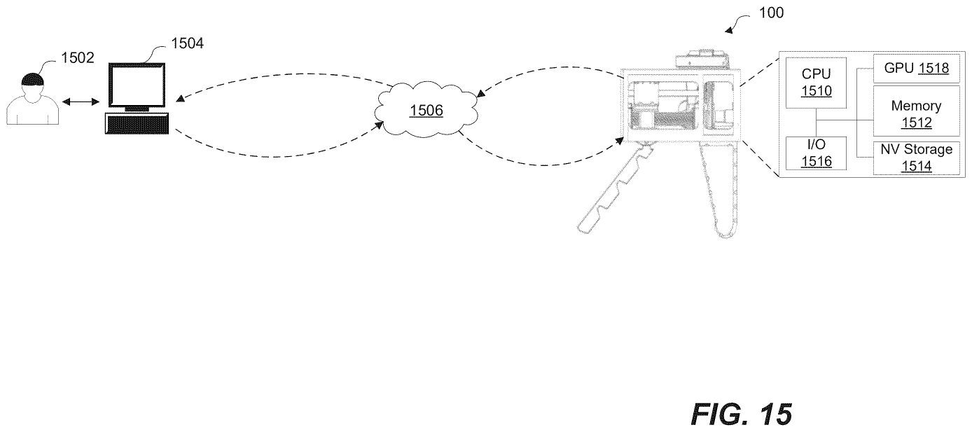

FIG. 15 depicts a robotic gripper system comprising the robotic gripper 100. A user 1502 may interact with the robotic gripper 100 via a device 1504 over a communications network 1506 (e.g. the internet). The device 1504 may be a computer, as depicted in FIG. 15, but is not restricted to those devices expressly shown and may be any suitable device known in the art such as smart phones and tablets. The robotic gripper 100 may be coupled to or controllable via a graphical user interface (GUI) on the device 1504 for ease of communication and operation control by the user. The implementation of the GUI is not restrictive and may be, for example, a mobile/computer application or a web page. The GUI can be used to provide input (e.g. control signal and sensor/other data) to and receive output from the robotic gripper 100. Additionally or alternatively, other user interfaces, such as an audio interface that allows receipt and processing of spoken commands may be used.

The user 1502 may be interested in performing gripping operations using the robotic gripper 100. The robotic gripper 100 may be configured to process the instructions and to perform gripping operations. In particular, the robotic gripper 100 can comprise a microcontroller 126 or other suitable processing unit(s) to perform signal processing, transmission, and data processing, as described above. Sensor data such as data from cameras 118, 120 may be processed at the microcontroller 126 or externally, for example at the device 1504. Additional data such as object properties and 3D representations can be received from or processed at the device 1504, for example over the communications network 1506. It should be noted that other forms of communication such as Bluetooth and near-field communication between the robotic gripper 100 and the device 1504 are possible as well.

In a particular implementation, the robotic gripper 100 (e.g. the microcontroller 126) can comprise a CPU 1510, a non-transitory computer-readable memory 1512, non-volatile storage 1514, an input/output interface 1516, and a graphical processing unit (“GPU”) 1518. The non-transitory computer-readable memory 1512 comprises computer-executable instructions stored thereon at runtime which, when executed by the CPU 1510, configure the robotic gripper 100 to perform the gripping operation. The non-volatile storage 1514 has stored on it computer-executable instructions that are loaded into the non-transitory computer-readable memory 1512 at runtime. The input/output interface 1516 allows the robotic gripper 100 to communicate with one or more external devices such as the device 1504 (e.g. via network 1506). The non-transitory computer-readable memory 1512 may also have stored thereon the LLM 904. The GPU 1518 may be used to control a display and may be used to process the sensor data from the cameras 118, 120. In some embodiments, the LLM 904 may be stored at one or more external servers. The robotic gripper 100 and the device 1504 may each provide a communications interface which allows software and data to be transferred, for example between the robotic gripper 100 and the device 1504 over the communications network 1506.

The CPU 1510 and GPU 1518 may be one or more processors or microprocessors, which are examples of suitable processing units, which may additionally or alternatively comprise an artificial intelligence accelerator, programmable logic controller, a microcontroller (which comprises both a processing unit and a non-transitory computer readable medium), neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

It should be noted that while FIG. 1 depicts the device 1504 and the robotic gripper 100 as separate entities coupled over the communication network 1506, the device 1504 and robotic gripper 100 may also be coupled directly/physically using cable(s) for data transfer. In some embodiments, the robotic gripper 100 may also be the device 1504 or comprise the device 1504.

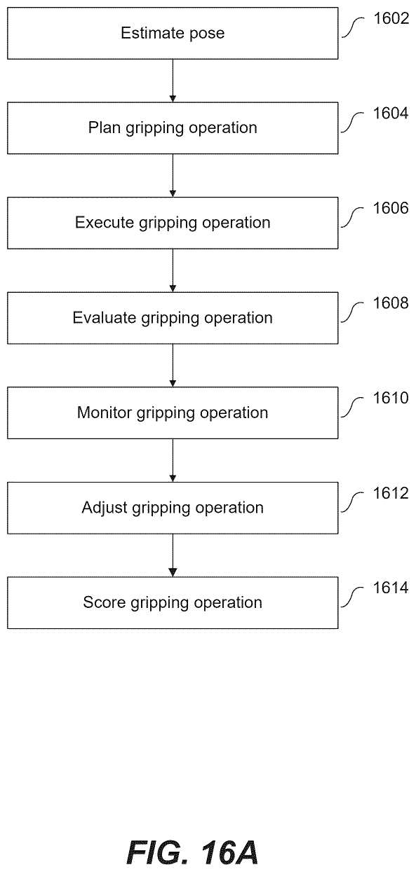

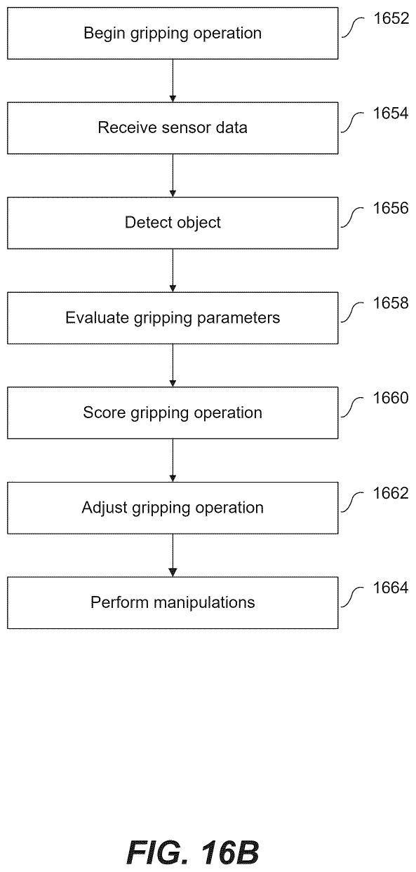

FIG. 16A depicts a first method for performing gripping operation on an object using the robotic gripper 100. At 1602, the pose of the object and the grasp (e.g. gripping operation) can be estimated, as described above. At 1604, the gripping operation can be planned, for example using the sensor data from cameras 118, 120 as well as data from the LLM 904 and CAD models 902, as described above. Further, contact points and contact force can be estimated. At 1606, the robotic gripper 100 executes the gripping operation. At 1610, the gripping operation can be evaluated, for example based on the quality of the gripping operation, as described above. The gripping operation can be continuously monitored at 1610 and adjusted at 1612, for example if deterioration of the gripping operation is detected using the sensor data. The gripping operation can also be scored at 1614, for example once the object is grasped and prior to moving the grasped object.

FIG. 16B depicts a second method for performing gripping operation on an object using the robotic gripper 100, which can be combined with the first method shown in FIG. 16A. In the current embodiment, gripping operation is the grasping of an object.

At 1652, the gripping operation begins by using the gripper 100 to grasp an object. Sensor data such as those from the cameras 118, 120 are continuously received and processed during the operation at 1654. At 1656, object detection is performed (e.g., at the ROI) to detect if the object has been grasped. At 1658, the sensor data is processed to calculate the grasping parameters. In particular, the conformity, deformity, and slippage values may be determined from the sensor data. At 1660, the gripping operation is evaluated using the calculated parameters and based on whether the object was detected, for example as failure, bad, good, or robust. At 1662, the gripping operation is adjusted to improve the grasp. For a failed grasp, the object can be regrasped; for a bad grasp, the grip on the object by the fingers 102, 104 can be adjusted to correct the grasp. The gripping operation evaluation and adjustment can be continuously performed in real-time. Once the gripping operation is evaluated as good or robust, the gripper 100 can execute further manipulation of the object at 1664, such as moving and placing the object.

### Experimental Results

A series of experiments was conducted with an example embodiment of the gripper 100 to assess performance under various conditions, emphasizing manipulation intensity and the object's position in the grasp. A baseline test evaluates the core grasping capability, while two key experiments explored the adaptability to distinct grasp configurations, and its resilience against external disturbances.

### Experiment 1: Grasping Diversity

An experiment was conducted to assess the baseline performance of the gripper 100. The primary objective is to evaluate its adaptability across various shapes, sizes, and weights, providing a foundation for the following experiments. The experiment utilized 25 objects from the YCB object set, ranging from lightweight utensils and deformable items to rigid objects weighing up to 200 g. The gripper's performance was analyzed across all grasp types to ensure a comprehensive evaluation. Results indicated that the gripper successfully held 20 of the 25 objects, showcasing its versatility.

### Experiment 2: Manipulation Reliability

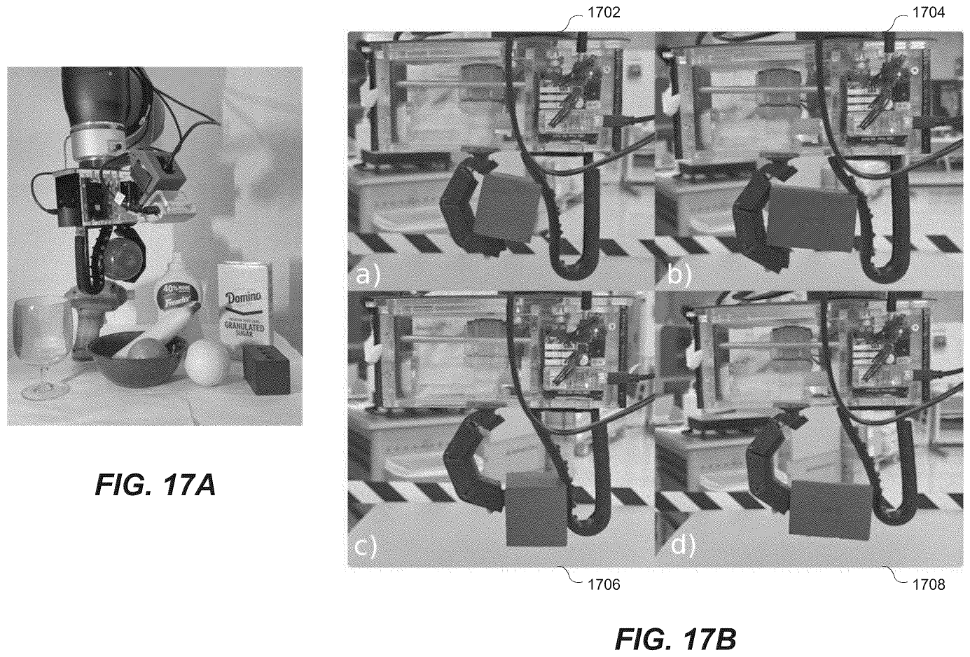

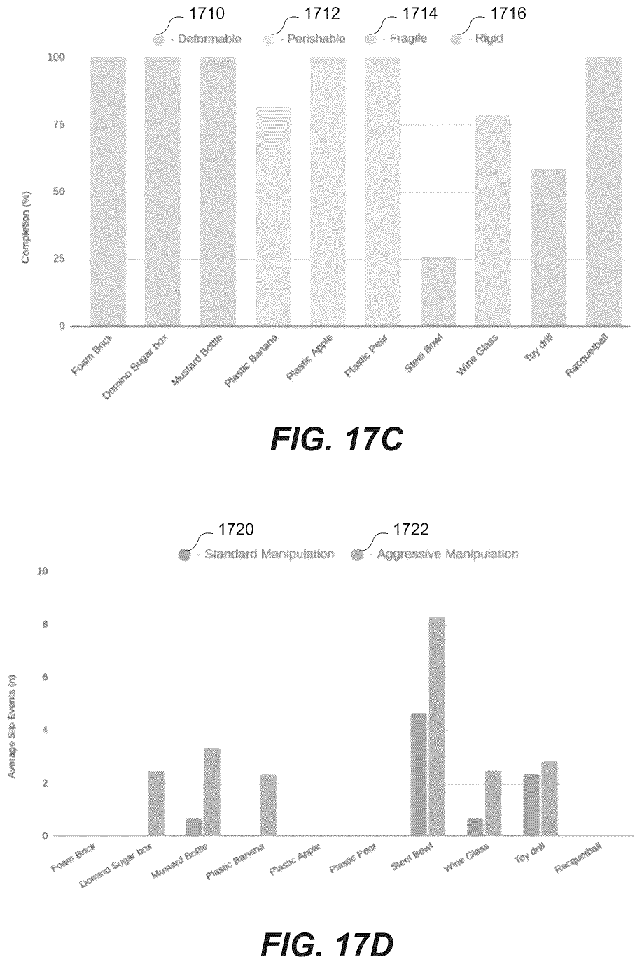

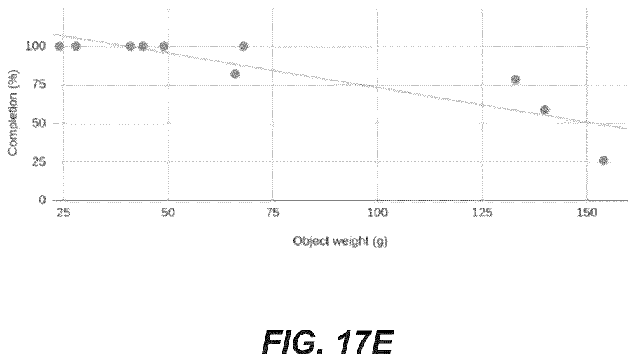

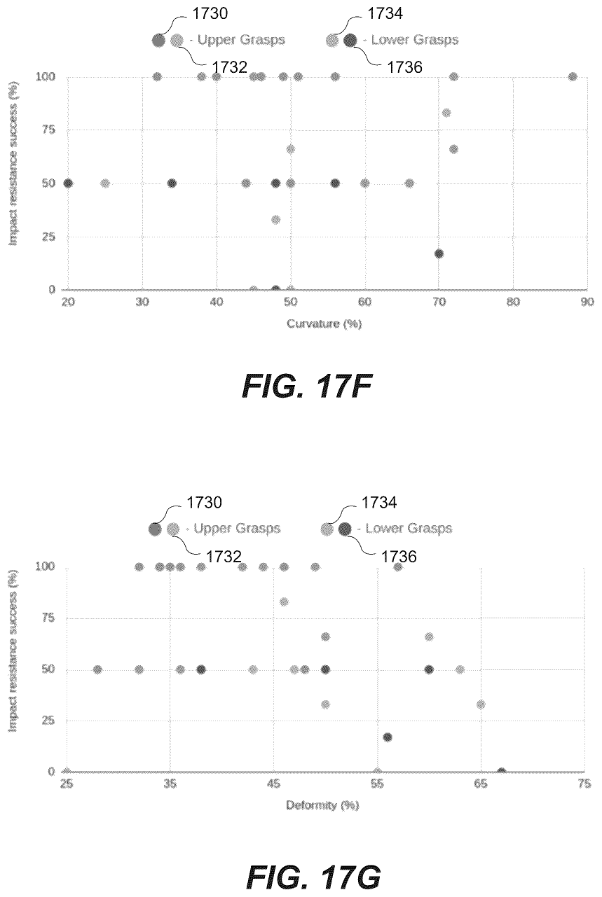

The gripper's reliability was assessed by conducting manipulation tests under two distinct routines: a standard manipulation routine and an aggressive manipulation routine. To thoroughly investigate the influence of grasp position, 10 different objects were tested, each subjected to 4 grasp configurations, repeated 4 times per configuration, resulting in a total of 160 trials per routine. FIG. 17A depicts the objects tested. The 4 configurations were divided into top grasps, comprising ring and inferior pincer grasps, and lower grasps, consisting of tip and palmar pinch grasps, to evaluate the impact of grasp type on performance. The grasping configurations are shown in FIG. 17B. 1702 and 1704 depict the top grasps and 1706 and 1708 depict the lower grasps.

The completion of each routine was measured as a percentage, reflecting the gripper's success in executing the manipulation task without dropping the object. Additionally, the number of slip events was quantified during each test, averaged across 3 iterations per grasp configuration, to determine a total slip count. For the graphical representation, routine completion (%) was plotted against each object to assess reliability trends. FIG. 17C shows the completion of aggressive manipulation for 10 sample objects, represented as a percentage of the 34.4 second manipulation routine. This represents the completed portion of the manipulation routine without dropping the object. In FIG. 17C, 1710, 1712, 1714, and 1716 respective correspond to deformable, perishable, fragile, and rigid objects. FIG. 17D depicts slip events numbers for each object, with parallel bars to compare standard and aggressive manipulation routines. In FIG. 17D, standard and aggressive manipulation slip events are shown as 1720 and 1722, respectively. During the standard manipulation tests, all objects across all grasp configurations achieved a 100% completion rate, with some objects experiencing minor slippage as shown in FIG. 17D. In the aggressive manipulation tests, approximately half of the objects exhibited failure in varying degrees, yielding an average completion rate of 91%, taking the steel bowl as an outlier. The gripper 100 demonstrated consistency in handling deformable and perishable objects, which averaged higher completion rates compared to fragile and rigid objects. This reflects the influence of object weight on grasp reliability. FIG. 17E depicts a graph showing the relationship between object weight and manipulation completion, which shows a significant negative correlation showing how a target object for in-hand manipulation can affect reliability.

### Experiment 3: External Disturbance

The gripper's resilience was assessed by testing its ability to hold objects under controlled impacts, reflecting potential real-world conditions. A pendulum rig that delivers a uniform 0.45 J impact energy was used to simulate knocks or sudden disturbances to the object. Each test was repeated 3 times for each of the 4 grasp configurations across the 10 objects, totaling 120 trials. The performance was scored as follows: 1 for retaining the object without slipping, 0.5 for slipping but retaining, and 0 for dropping it entirely. The iterations were then averaged to produce an impact resistance metric for each configuration. The outcomes were plotted against 2 proprioceptive features (separately) to evaluate potential correlations between them and the success of the grasp. FIG. 17F compares impact resistance versus curvature, while FIG. 17G compares impact resistance versus deformity. FIG. 17F depicts a scatter graph of impact resistance success (%) vs. thumb curvature (%), measured by the grasp success prediction system, with upper grasps shown as 1730 and 1732 and lower grasps shown as 1743 and 1736. FIG. 17G depicts a scatter graph of impact resistance success (%) vs. thumb deformity (%), with upper grasps shown as 1730 and 1732 and lower grasps shown as 1743 and 1736.

The results revealed that upper grasps consistently resist disturbances with success rates of approximately 90% across a thumb curvature range of 30% to 55%, and a deformity range of 30% to 50%. In contrast, lower grasps performed worse and exhibited some form of slip in every combination of both features. These observations revealed that moderate curvature and deformity levels correlate with higher success in upper grasps, likely due to better force distribution across the contact area. In terms of lower grasps, no clear correlation was drawn, making them a valid condition for regrasping. The grasp success prediction can leverage the relationship between these curvature and deformity metrics and grasp success to classify future grasps.

Accordingly, the disclosed soft gripper 100 can address grasp uncertainty through compliant design and real-time multimodal sensing. The gripper 100 exhibited notable adaptability across a variety of objects and manipulation settings. Experimental evaluations, including baseline tests with the YCB object set, demonstrated a grasp success rate of 80% across the object set sample, highlighting its versatility.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification, so long as such parts are not mutually exclusive with each other.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components. Further, as used herein, the term “comprising” can mean “including.” Variations of the word “comprising”, such as “comprise” and “comprises,” have correspondingly varied meanings. Thus, for example, a composition “comprising” X may consist exclusively of X or may include one or more additional unrecited components. It will be understood that in embodiments which comprise or may comprise a specified feature or variable or parameter, alternative embodiments may consist, or consist essentially of such features, or variables or parameters. A reference to an element by the indefinite article “a” does not exclude the possibility that more than one of the elements is present, unless the context clearly requires that there be one and only one of the elements.

Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

The terms are not to be interpreted to exclude the presence of other features, steps or components. Further, the singular forms “a”, “an”, and “the” are intended to include the plural forms as well, unless the context clearly indicates otherwise.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present. Further, in this disclosure, the term “or” is generally employed in its sense including “and/or” unless the content clearly dictates otherwise.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied herein disclosed may be resorted to by those skilled in the art, and that such modifications and variations are considered to be within the scope of this invention.

1. A robotic gripper, comprising:
a microcontroller;
a chassis;
a first sensor and a second sensor coupled to the chassis and configured to provide sensor data to the microcontroller; and
a first appendage and a second appendage coupled to the chassis and controllable by the microcontroller to perform gripping operation on an object;
wherein the microcontroller is configured to process sensor data to evaluate the gripping operation and to execute the gripping operation using the first appendage and a second appendage based on the sensor data.

2. The robotic gripper of claim 1,
wherein the first sensor is a RGB-D camera or a RGB camera coupled to a depth sensor; and
wherein the sensor data comprises first sensor data provided by the first sensor and comprising RGB frames and depth frames.

3. The robotic gripper of claim 1,
wherein the second sensor is a neuromorphic camera; and
wherein the sensor data comprises second sensor data provided by the second sensor and comprising event frames and/or event streams.

4. The robotic gripper of claim 1,
wherein the first appendage and/or the second appendage is a cable driven appendage;
wherein the cable driven appendage comprises a cable along a longitudinal direction thereof actuatable to curl the cable driven appendage in a direction of the gripping operation; and
wherein the cable driven appendage is formed from a soft material.

5. The robotic gripper of claim 1,
wherein the first appendage and/or the second appendage is a belt driven appendage;
wherein the belt driven appendage comprises a belt configured to move in a direction of the gripping operation; and
wherein the belt driven appendage is formed from a high-friction and/or soft material.

6. The robotic gripper of claim 5, wherein the belt driven appendage comprises a plurality of markers for evaluation of the gripping operation.

7. The robotic gripper of claim 1,
wherein the chassis comprises a plurality of modular compartments coupled thereto;
wherein each of the plurality of the compartments corresponds to a respective appendage and comprises:
a first actuator configured to control a movement of the respective appendage to perform the gripping operation; and
a second actuator configured to control a distance of the respective appendage to another appendage.

8. The robotic gripper of claim 1, further comprising one or more additional appendages.

9. The robotic gripper of claim 1, wherein the gripping operation is gripping, grasping, tapping, caging, pivoting, picking, pushing, sliding, holding, or combinations thereof.

10. The robotic gripper of claim 1, wherein the second sensor data is for evaluating a contact between the first appendage and/or second appendage with the object.

11. The robotic gripper of claim 1, wherein the microcontroller is configured to receive a 3D representation of the first appendage, second appendage, and/or the object for evaluating the gripping operation and/or object detection.

12. The robotic gripper of claim 1, wherein the microcontroller is configured to receive object properties comprising: deformability, size, weight, material properties, or combinations thereof from a large language model for evaluating the gripping operation.

13. The robotic gripper of claim 1, wherein the microcontroller is configured to classify a quality of the gripping operation to evaluate the gripping operation using a scoring system.

14. A method for performing gripping operation on an object using a robotic gripper, comprising:
estimating a pose of the object by using 3D representations of the object and the robotic gripper to perform region of interest detection to estimate the pose;
planning the gripping operation based on the pose using sensor data and object properties determined by a large language model to determine contact point and the gripping operation;
executing the gripping operation using the robotic gripper; and
evaluating the gripping operation using sensor data.

15. The method of claim 14, wherein evaluating the gripping operation comprises:
monitoring the gripping operation using the sensor data;
adjusting the gripping operation using the sensor data; and
scoring the gripping operation using the sensor data.

16. The method of claim 14, wherein monitoring the gripping operation comprises evaluating a contact between the robotic gripper and the object and adjusting the gripping operation comprises adjusting the gripping operation using the object properties.

17. The method of claim 16, wherein evaluating the contact between the robotic gripper and the object comprises:
detecting overlap between the robotic gripper and the object from pixel changes in the sensor data;
evaluating kinematics of the robotic gripper using visual data of markers on the robotic gripper; and
detecting contact and/or slippage between the object and the robotic gripper.

18. A robotic manipulator comprising the robotic gripper of claim 1.

19. A robotic gripper system comprising:
a microcontroller comprising at least one processing unit;
a chassis;
a first sensor and a second sensor coupled to the chassis and configured to provide sensor data to the microcontroller; and
a first appendage and a second appendage coupled to the chassis and controllable by the microcontroller to perform gripping operation on an object;
wherein the at least one processing unit is configured to perform the method of claim 14.

20. At least one non-transitory computer readable medium having stored thereon computer instruction, which, when executed by at least one processor, causes the at least one processor to perform the method of claim 14.
